(19) United States
(12) Patent Application Publication
(10) Pub. No.: US 2026/0287804 A1
(43) Pub. Date: Sep. 24, 2026

(54) Optical Stack Including Microstructures on an Optical Film

(71) Applicant: 3M INNOVATIVE PROPERTIES COMPANY, St. Paul, MN (US)

(72) Inventors: Ehsan Nahvi, Woodbury, MN (US); Xuexue Guo, St. Paul, MN (US); John A. Wheatley, Stillwater, MN (US); Lin Zhao, Woodbury, MN (US); Gilles J. Benoit, Minneapolis, MN (US); Caitlin M. Race, Stillwater, MN (US); Nicholas C. Erickson, St. Paul, MN (US)

(21) Appl. No.: 19/475,528

(22) PCT Filed: Apr. 18, 2024
(86) PCT No.: PCT/IB2024/053802

§ 371 Date: Oct. 15, 2025

Related U.S. Application Data
(60) Provisional application No. 63/498,836, filed on Apr. 28, 2023.

(51) Int. Cl. G02B 5/18

(52) U.S. Cl. CPC G02B 5/18

(57) ABSTRACT

An optical stack includes a plurality of microstructures arranged on and across an optical film, such that for a same first polarization state, a same first optical property, and for a first incident angle and a second incident angle that is greater than the first incident angle by at least about 10 degrees, the first optical property of each of the optical film and stack remains within about 20% of a same P1 as incident angle and wavelength of the incident light change from the first incident angle at a first wavelength to the second incident angle at a second wavelength. A magnitude of a difference between the first and second wavelengths is greater for the optical film than for the optical stack by at least about 10%.

### TECHNICAL FIELD

The present description relates generally to optical stacks and films, and more specifically, to optical stacks including microstructures arranged on optical films.

### BACKGROUND

Microstructures can be disposed on a film. An optical film can be reflective over a wavelength range for a range of incident angles of incident light.

### SUMMARY

Multilayer optical films including alternating layers of high and low refractive index subwavelength polymeric layers have been used for several decades to reflect certain wavelengths and/or incident angles of light while transmitting others. However, a limitation of such conventional multilayer optical films is that the reflection band (as determined by the range of wavelengths with substantial reflectivity) typically blue shifts with increasing incident angles. Optical microstructures, which can define an optical metasurface, for example, are capable of manipulating the amplitude, phase, and polarization of light with great flexibility. For example, a metasurface (or other surface including subwavelength microstructures) can selectively reflect and/or deflect light for specific wavelengths, incident angles, and polarizations. It has been found, according to some embodiments of the present description, that the additional degrees of freedom provided by arranging microstructures on a (e.g., multilayer) optical film allows the angular and/or wavelength dependence of reflectance and/or transmittance to be controlled with greater flexibility in a manner not available for either of the two components (microstructures and optical film) individually. As a result, according to some embodiments, an optical stack may be designed so that the optical stack is substantially transmissive for a range of incident angles and wavelengths where the optical film is substantially reflective while, conversely, the optical stack may exhibit substantial reflection for a different range of incident angles and wavelengths where the optical film is substantially transmissive. In some aspects, the present description provides an optical stack including a plurality of microstructures arranged on and across an optical film for engineering wavelength and/or incident angle dependence of transmittance and/or reflectance of the optical stack, for example.

In some aspects, the present description provides an optical stack including a plurality of microstructures arranged on and across an optical film, such that for a substantially collimated incident light, a same first polarization state, a same first optical property, and a same first wavelength range that is at least about 10 nm wide and lies within a predetermined wavelength range extending from about 400 nm to about 2000 nm: the first optical property of the optical film and stack have respective average magnitudes S1 and S2 in the first wavelength range for a same incident angle of less than about 10 degrees, where S1 and S2 can be within about 20% of each other; and for a first incident angle and a second incident angle that is greater than the first incident angle by at least about 10 degrees, the first optical property of each of the optical film and stack remains within about 20% of a same P1, where P1≥0.3 S1, as incident angle and wavelength of the incident light change from the first incident angle at a first wavelength to the second incident angle at a second wavelength. A magnitude of a difference between the first and second wavelengths is greater for the optical film than for the optical stack by at least about 10%.

In some aspects, the present description provides an optical stack including a plurality of microstructures arranged on and across an optical film, such that for a substantially collimated incident light, a same first polarization state, a same first optical property, and a same first wavelength range that is at least about 10 nm wide and lies within a predetermined wavelength range extending from about 400 nm to about 2000 nm: the first optical property of the optical film and stack have respective average magnitudes S1 and S2 in the first wavelength range for a same incident angle of less than about 10 degrees, where S1 and S2 can be within about 20% of each other; and for a first incident angle and a second incident angle that is greater than the first incident angle by at least about 10 degrees, the first optical property of each of the optical film and stack is within about 20% of a same P1, where P1≥0.3 S1, as incident angle and wavelength of the incident light changes from the first incident angle at a first wavelength to the second incident angle at a second wavelength. Differences between the first and second wavelengths for the optical film and stack have opposite signs.

In some aspects, the present description provides an optical stack including a plurality of microstructures arranged on and across an optical film, such that for a substantially collimated incident light, for a same first polarization state, for a predetermined wavelength range extending from about 400 nm to about 2000 nm, and for a first incident angle less than about 10 degrees and a second incident angle greater than the first incident angle by at least about 30 degrees, optical transmittance of each of the optical stack and film defines a largest continuous range of wavelength that lies within the predetermined wavelength range where the optical transmittance is no greater than about 25%. The largest continuous range of wavelength extend from a shorter first wavelength to a longer second wavelength. For at least a same one of the first and second wavelengths, a magnitude of a difference between the wavelength at the first incident angle and the wavelength at the second incident angle is greater for the optical film than for the optical stack by at least about 10%. For the optical film and for at least one of the first and second incident angles, a difference between the second and first wavelengths can be at least about 1% of an average of the first and second wavelengths.

In some aspects, the present description provides an optical stack including a plurality of microstructures arranged on and across an optical film, such that for a substantially collimated incident light, for a same first polarization state, for a same first wavelength range that is at least about 5 nm wide and lies within a predetermined wavelength range extending from about 400 nm to about 2000 nm, and for first and second incident angles differing from one another by at least about 30 degrees, where one of the first and second incident angles is less than about 10 degrees: the optical film and optical stack have respective average optical transmittances T1 and T2 in the first wavelength range for the first incident angle where T1 is greater than about 65% and T2 is less than about 40%; and the optical film and optical stack can have respective average optical transmittances T1′ and T2′ in the first wavelength range for the second incident angle where each of T1′ and T2′ can be less than about 25%.

In some aspects, the present description provides an optical stack including a plurality of microstructures arranged on and across an optical film, such that for a substantially collimated incident light, for a same first polarization state, and for a same first incident plane: optical transmittances of the optical stack and the optical film as a function of incident angle and wavelength of the incident light define a largest continuous region of incident angle and wavelength within a predetermined wavelength range extending from about 400 nm to about 2000 nm, where the optical transmittance is less than a same first transmittance where the first transmittance can be in a range of about 30% to about 50% and where the largest continuous region is at least about 10% larger for the optical film than for the optical stack; and for a same first wavelength range that is at least about 10 nm wide and lies within the predetermined wavelength, the optical film and stack have respective average optical transmittances S1 and S2 in the first wavelength range for a same incident angle of less than about 10 degrees where S1 and S2 can be within about 20% of each other.

In some aspects, the present description provides an optical stack including a plurality of microstructures arranged on and across an optical film, such that for a substantially collimated incident light, for a same first polarization state, for a same first incident plane, and for a predetermined wavelength range extending from about 400 nm to about 2000 nm: for a largest continuous range of incident angle at a constant wavelength in the predetermined wavelength range, and a largest continuous range of wavelength that lies within the predetermined wavelength range at a constant incident angle, where optical transmittances of the optical stack and the optical film are each less than a same first transmittance where the first transmittance can be in a range of about 30% to about 50%, at least one of the continuous range of wavelength and the continuous range of incident angle is at least about 10% larger for the optical film than for the optical stack; and for a same first wavelength range that is at least about 10 nm wide and lies within the predetermined wavelength range, the optical film and stack have respective average optical transmittances S1 and S2 in the first wavelength range for a same incident angle of less than about 10 degrees where S1 and S2 can be within about 20% of each other.

In some aspects, the present description provides an optical stack including a plurality of microstructures arranged on and across an optical film, such that for a substantially collimated incident light, for a same first polarization state, for a first incident angle greater than about 10 degrees, for first and second azimuthal angles differing by at least about 10 degrees, and for different first and second wavelengths in a predetermined wavelength range extending from about 400 nm to about 2000 nm: for the first wavelength, optical transmittances of the optical stack for the incident light incident at the first incident angle and the first azimuthal angle and for the incident light incident at the first incident angle and the second azimuthal angle are within about 15 percent of each other; and for the second wavelength, optical transmittances of the optical stack for the incident light incident at the first incident angle and the first azimuthal angle and the incident light incident at the first incident angle and at the second azimuthal angle differ from each other by greater than about 20 percent.

In some aspects, the present description provides an optical stack including a plurality of microstructures arranged on and across an optical film, such that for a range of incident angles at least about 10 degrees wide, the optical stack and the optical film have a same first optical property over the range of incident angles for light incident on the respective optical stack and optical film for at least a first polarization state and for at least a first wavelength in a predetermined wavelength range extending from about 400 nm to about 2000 nm, where the first optical property varies by respective first and second amounts for the respective optical stack and optical film over the range of incident angles for the first wavelength and the first polarization state. The plurality of microstructures causes the first amount to be substantially different from the second amount.

These and other aspects will be apparent from the following detailed description. In no event, however, should this brief summary be construed to limit the claimable subject matter.

### BRIEF DESCRIPTION OF THE DRAWINGS

FIG. 1 is a schematic illustration of a light rays in an incident plane.

FIGS. 2-5 are schematic cross-sectional views of optical stacks, according to some embodiments.

FIG. 6 is a schematic top perspective view of an optical stack including extended microstructures, according to some embodiments.

FIG. 7 is a schematic cross-sectional view of a portion of an optical stack, according to some embodiments.

FIG. 8 is a schematic top perspective view of an optical stack including an array of microstructures, according to some embodiments.

FIG. 9 is a schematic plot of an optical property versus wavelength, according to some embodiments.

FIGS. 10A-10B are contour plots of optical transmittance of an optical film and stack, respectively, as a function of incident angle and wavelength, for p-polarized light, according to some embodiments.

FIGS. 11-14 are plots of optical transmittance versus wavelength for the optical film and stack of FIGS. 10A-10B for various incident angles.

FIG. 15 is a plot of optical transmittance versus incident angle for the optical film and stack of FIGS. 10A-10B for various wavelengths.

FIGS. 16A-16B are contour plots of optical transmittance of another optical film and stack, respectively, as a function of incident angle and wavelength, for p-polarized light, according to some embodiments.

FIG. 17 is a plot of optical transmittance versus wavelength for the optical film and stack of FIGS. 16A-16B for various incident angles.

FIG. 18 is a plot of optical transmittance versus incident angle for the optical stack of FIG. 16B for various wavelengths.

FIGS. 19A-19B are contour plots of optical transmittance of an optical film and optical stack, respectively, as a function of incident angle and wavelength, for s-polarized light, according to some embodiments.

FIG. 20 is plot of optical transmittance versus wavelength for the optical film and stack of FIGS. 19A-19B for various incident angles.

FIGS. 21A-21B are plots of optical transmittance versus wavelength for the optical film and stack, respectively, of FIGS. 19A-19B for incident angles of 0 degrees and 60 degrees.

FIGS. 22A-22B are plots of optical transmittance versus wavelength for the optical film and stack of FIGS. 19A-19B for incident angles of 0 degrees and 50 degrees, respectively.

FIGS. 23A-23B are contour plots of optical transmittance of another optical film and stack, respectively, as a function of incident angle and wavelength, for s-polarized light, according to some embodiments.

FIGS. 24A-24B are contour plots of optical transmittance of the optical film and stack, respectively, of FIGS. 23A-23B as a function of incident angle and wavelength, for p-polarized light, according to some embodiments.

FIGS. 25A-25B are plots of optical transmittance versus wavelength for the optical film and stack, respectively, of FIGS. 23A-23B for incident angles of 0 degrees and 40 degrees and for s-polarized incident light.

FIGS. 26A-26B are plots of optical transmittance versus wavelength for the optical film and stack, respectively, of FIGS. 24A-24B for incident angles of 0 degrees and 40 degrees and for p-polarized incident light.

FIG. 27 is a plot of optical transmittance versus wavelength for the optical film, optical stack, and the plurality of microstructures of FIGS. 23A-24B for an incident angle of 0 degrees.

FIG. 28 is a plot of optical transmittance versus wavelength for the optical film, optical stack, and the plurality of microstructures of FIGS. 23A-23B for an incident angle of 50 degrees for s-polarized incident light.

FIG. 29 is a plot of optical transmittance versus wavelength for the optical film, optical stack, and the plurality of microstructures of FIGS. 24A-24B for an incident angle of 50 degrees for p-polarized incident light.

FIG. 30 is a schematic cross-sectional view of an optical system including an optical stack and an optical element, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An optical film can have a reflection band having a band edge that shifts to shorter wavelengths with increasing incident angles of an incident light. However, for some applications, this shift in band edge to shorter wavelengths for increasing incident angles may not be desired. Instead, it can be desired to reduce a magnitude of the shift and/or change a sign of the shift so that the band edge shifts to longer wavelengths with increasing incident angles.

In some embodiments of the present description, an optical stack includes a plurality of microstructures arranged on and across an optical film. The microstructures may be selected such that the optical film and the optical stack have a same optical property (e.g., optical transmittance, optical reflectance, or position of a band edge) having a variation with at least one of incident angle and wavelength, where the microstructures cause the variation for the optical stack to be substantially different from the variation of the optical film. For example, in some embodiments, the optical film has a reflection band (or a band edge of the reflection band) that shifts in wavelength with changing incident angle and the optical stack has a corresponding reflection band (or a corresponding band edge of the corresponding reflection band) with a substantially reduced shift in wavelength with changing incident angle. As another example, in some embodiments, the optical film has a reflection band edge that shifts to decreasing wavelengths with increasing incident angle and the optical stack has a corresponding reflection band edge that shifts to increasing wavelengths with increasing incident angle.

As used herein, a “microstructure” is a structure having at least two orthogonal dimensions (two dimensions along two orthogonal directions or three dimensions along three mutually orthogonal directions) in a range of 1 nm to 1 mm. The microstructures are typically engineered structures (e.g., microstructures having engineered or predetermined geometries). In some embodiments, a microstructure has a width along a width direction and a height along an orthogonal height direction that are each in a range of 1 nm to 1 mm. The microstructure can have a length along a length direction orthogonal to each of the width and height directions that is also in a range of 1 nm to 1 mm, for example, or the length can be longer than 1 mm. For example, the microstructure can be extended along the length direction (e.g., along a length of a film) so that the length is greater than 0.1, 0.5, 1, 5, or 10 cm, for example. In some embodiments, a microstructure has at least two orthogonal dimensions that are each in a range of 10 nm to 100 micrometers, or 15 nm to 10 micrometers, or 20 nm to 1 micrometer, or 25 nm to 700 nm, or 30 nm to 400 nm, for example. The length scales of the microstructures may be selected based on wavelengths of light desired to be redirected or reflected, for example, by the microstructures. For visible light, for example, the microstructures may be nanostructures. As used herein, a “nanostructure” is a microstructure having at least one dimension that is less than 1 micrometer. A nanostructure can have one dimension, two orthogonal dimensions, or three mutually orthogonal directions less than 1 micrometer. In some embodiments, an optical stack includes a plurality of microstructures arranged on and across an optical film, where each microstructure of the plurality of microstructures has a first width along a first in-plane direction, a second width along a second in-plane direction orthogonal to the first in-plane direction, and a height in a thickness direction orthogonal each of the first and second in-plane directions. In some embodiments, at least one of the first and second widths is in a range of about 10 nm to about 1000 nm, or about 50 nm to 800 nm. In some embodiments, the height is in a range of about 5 nm to about 1000 nm, or about 10 nm to about 600 nm. In some embodiments, each pair of adjacent microstructures are spaced apart along at least one of the first and second in-plane directions by a gap in a range of about 10 nm to about 1000 nm, or about 50 nm to 600 nm.

The microstructures can be made by any suitable processes. Useful processes include microreplication processes, for example. Microreplication refers to a continuous thermal or photochemical process for creating a microstructured surface layer using a (e.g., cylindrical) tool with a thermoplastic (thermal) or radiation curable (photochemical) material. The microstructured surface layer may be created directly on the optical film or may be created on a support film which is subsequently stacked on an optical film and optionally bonded to the optical film via an optically clear adhesive, for example (note that a first optical film with the support film stacked on, or bonded to, the first optical film may be considered to be a second optical film so that the microstructures are disposed directly on the second optical film). For example, the microstructures can be formed in a cast and cure process using microreplication from a tool by casting and curing a polymerizable resin composition in contact with a structured surface of the tool. Such cast and cure methods are described in U.S. Pat. No. 5,175,030 (Lu et al.) and U.S. Pat. No. 5,183,597 (Lu) and in U.S. Pat. Appl. Pub. No. 2012/0064296 (Walker, J R. et al.), for example. In some embodiments, the microstructures are formed via lithographic processes. Lithographic processes, such as those utilizing optical or electron-beam nanolithography, are useful for forming nanostructures, for example. Traditional lithographic processes achieve pattern definition by photon or electron beam exposure of a resist layer to modify the chemical and physical properties of the resist. Useful alternatives to traditional lithographic processes include nanoimprint lithograph (NIL) which can utilize a stamp in a direct mechanical deformation of the resist material. The stamp can be made from a master wafer and may be reused in a rapid process to produce many copies of the original pattern. NIL processes are described in U.S. Pat. Appl. Pub. No. 2022/0404525 (Wolk et al.), for example. Other useful processes are described in U.S. Pat. Appl. Pub. No. 2021/0347135 (van Lengerich et al.), for example.

In some embodiments, the optical film has an optical property (e.g., band edge wavelength) that changes with increasing incident angle and the plurality of microstructures alter this change so that the optical stack exhibits the same optical property with a smaller, or otherwise different, change with increasing incident angle. In some embodiments, the plurality of microstructures changes a beam direction of an obliquely incident light beam, for example, so that the obliquely incident light beam is incident on the optical film at a less oblique incident angle and this change of incident angle of the beam results in an optical property changing differently with increasing incident angle for the optical stack and the optical film. In some embodiments, the plurality of microstructures changes an optical property (e.g., increases the reflectance) where the optical film provides a magnitude of the optical property that is different (e.g., lower) than desired over some range of incident angle. For example, the optical film may have a reflection band that moves to shorter wavelengths with increasing incident angle, and the plurality of microstructures may provide reflection at shorter wavelengths than those of the reflection band at normal incidence and that shifts less with increasing incident angles than the reflection band of the optical film. The plurality of microstructures can then compensate for the low reflectance of the optical film for low incident angles for wavelengths below the reflection band of the optical film so that a desired reflectance (the optical property in this example) is achieved over a desired wavelength range over a broader range of incident angles compared to that of the optical film.

The plurality of microstructures can define one or more of a grating, a blazed grating, a metagrating, and a metasurface, for example. In the case of a grating, the diffraction equation can be used to determine the directions of diffracted light which determine beam steering provided by the grating. The directions are determined by the ratio of the wavelength of the light to the pitch of the grating so that the pitch can be selected to provide desired diffraction directions for wavelengths desired to be steered. A blazed grating can be used to increase the diffraction efficiency for a diffraction order corresponding to a desired diffraction direction. For example, the height of the blazed grating can be selected to increase the diffraction efficiency of the m=1 diffraction order. A metagrating, which generally includes metasurface feature(s) arranged into repeating unit cells, can similarly be used to increase the diffraction efficiency for a given diffraction order. The metagrating may increase the diffraction efficiency more than the blazed grating over a larger range of wavelengths, for example. Dielectric or plasmonic metasurfaces, for example, can be used to provide reflection in a desired wavelength range with less dependence on incidence angle that that of typical polymeric multilayer optical films, for example. The range of wavelengths where the metasurface is reflective can be determined by the dimensions of the features of the metasurface.

A metasurface is generally a two-dimensional subwavelength spacing or array of photonic resonators or truncated waveguides, which preform one or more optical functions. Each array locally acts on one or more physical properties of light, specifically, amplitude, phase, or polarization. Types of metasurfaces include geometric phase metasurfaces and propagation phase metasurfaces. Geometric phase metasurfaces induce light phase shifts via spatially rotated identical nanostructures where each individual nanostructure acts as a half-wave plate. Propagation phase metasurfaces induce light phase shifts using linearly birefringent nanostructures with different lateral dimensions at each spatial position. The two approaches can also be used in combination.

Optical stacks including a metasurface can utilize the design of subwavelength structures or features that impart an abrupt phase shift at the interface of the subwavelength structures and the surrounding medium. Arranging these subwavelength structures or features on the optical film provides an operative phase profile of the metasurface. The term “operative phase profile” refers to the phase profile that is imparted by the metasurface on the incident electromagnetic radiation. It is designed to carry out specific optical functions. Thus, a predetermined operative phase profile of the optical metasurface film may be modeled to determine the arrangement of these subwavelength structures or features on the optical film.

Metasurfaces may utilize the design of subwavelength structures that can impart abrupt phase shifts at an interface. In particular, a phase gradient (do/dx) along a path on the interface leads to the generalized Snell's law of refraction:

$${n}_{t} sin ( {θ}_{t} ) - {n}_{i} sin ( {θ}_{i} ) = ( {λ}_{0} / 2 π ) ( d Φ / dx ) ,$$

where nᵢ and nₜ are the refractive indices experienced by the incident and transmitted light, θᵢ and θₜ are the angles of incidence and refraction, and λ₀ the incident wavelength in vacuum (see, e.g., Yu, et al., “Flat Optics with Designer Metasurfaces” Nature Materials, Vol. 13, February 2014, pp. 139-150). Therefore, implementing such a phase discontinuity at an interface allows for the creation of anomalous refraction.

There are many ways of designing an element that can impart a phase discontinuity for a metasurface. One useful approach for designing a metasurface is the Pancharatnam-Berry phase (or geometric phase) approach. This allows the use of a single element with different orientation angles, which can greatly reduce the number of optimization parameters. Furthermore, since the generated phase solely depends on the rotation angle of the basic nanostructure in this case, this approach is robust against fabrication errors since rotation angles are typically a well-controlled parameter in fabrication compared to the structure dimensions. The use of the Pancharatnam-Berry phase approach is described further in U.S. Pat. Appl. Pub. No. 2022/0404525 (Wolk et al.), for example.

Other useful approaches to designing metasurfaces are described in An et al., “Multifunctional Metasurface Design with a Generative Adversarial Network”, arXiv: 1908.04851v2, 2020; and Wang et al., “Plasmonic and Dielectric Metasurfaces: Design, Fabrication and Applications”, Appl. Sci., 2016, 6, 239, for example.

Standard optical modeling techniques may be utilized to simulate and analyze the properties of the microstructures and optical films and stacks. For example, a finite-difference time-domain (FDTD) solver may be utilized. Suitable FDTD solvers include Ansys Lumerical FDTD (available from Ansys Inc., Canonsburg, PA).

Various optical properties of optical films and optical stacks for an incident light can be determined as a function of wavelength, incident angle, and/or azimuthal angle of the incident light. For optical properties of an optical stack including microstructures, the incident light should be understood to be first incident on the microstructure side of the optical stack, unless indicated differently. An incident angle of an incident light incident on an optical film or stack is an angle between the incident light and a thickness direction of the optical film or stack and is in a range of 0 to 90 degrees. Light can be incident on the optical stack or film in an incident plane defined by a direction of the incident light and the thickness direction of the optical stack or film. In the case of a light beam (e.g., a substantially collimated light), the incident plane can be defined by a direction of a central light ray of the incident light and the thickness direction of the optical stack or film. Similarly, the incident angle of the light beam in this case is the angle between the central light ray and the thickness direction.

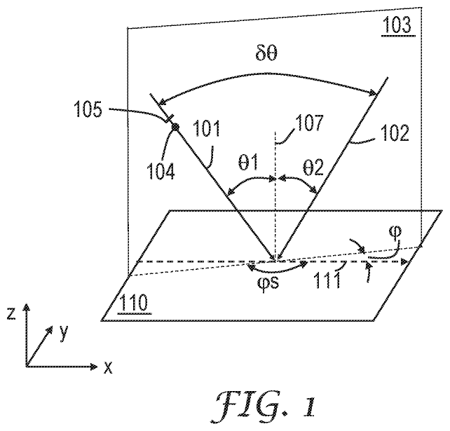

FIG. 1 is a schematic illustration of a light rays 101 and 102 incident on a plane 110 which can be a plane of an optical film or optical stack, for example, in which case the normal 107 to the plane 110 is the thickness direction of the optical film or optical stack. The light rays 101 and 102 can be central light rays of substantially collimated light beams. The light ray 101 is incident on the plane 110 at an incident angle θ1 and at an azimuthal angle q which is an angle between a direction of a projection of a propagation direction of the incident light ray 101 onto the plane 110 and a predetermined first in-plane direction 111 (e.g., +x-direction). The light ray 102 is incident on the plane 110 at an incident angle θ2 and at an azimuthal angle φs. Azimuthal angles can be taken to be in a range of −180 degrees to 180 degrees where the sign convention for the azimuthal angle is such that the azimuthal angle is positive between a predetermined first in-plane direction 111 (e.g., +x direction) and a predetermined second in-plane direction (e.g., +y-direction) orthogonal to the first in-plane direction 111, where the first and second in-plane directions are selected according to the right-hand rule so that the first in-plane direction crossed with the second in plane direction is in the thickness direction (e.g., +z direction) toward the incident light 101, 102. The azimuthal angle q depicted in FIG. 1 can be positive and the azimuthal angle φs can be negative, for example, such that the difference φ−φs is 180 degrees. The azimuthal angles φ and φs are supplementary in the sense that |φ|+|φs| is 180 degrees because these azimuthal angles are angles between a same plane 103 and an same direction 111.

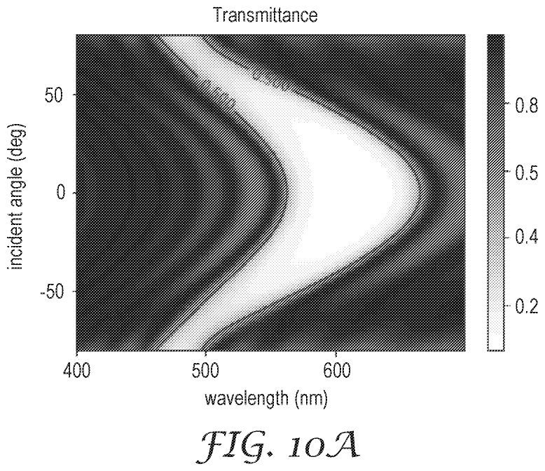

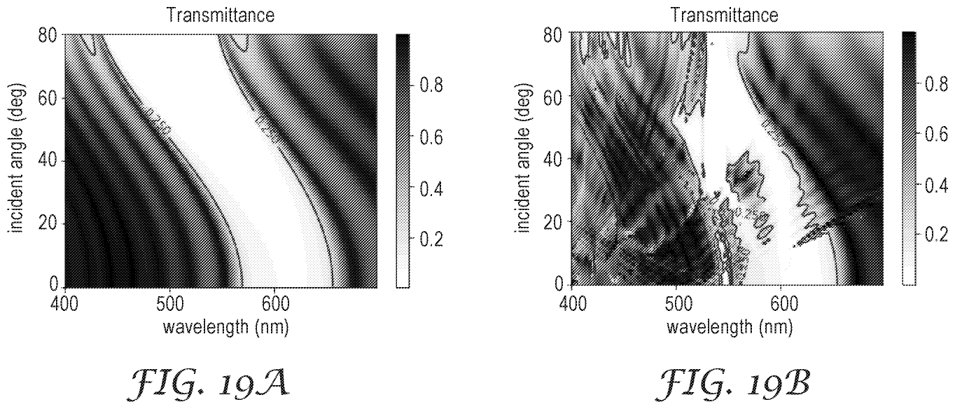

A width 80 of a continuous range of incident angles between those of light rays 101 and 102 in the incident plane 103 is given by θ1+θ2 since the directions of light rays in the incident plane 103 can vary continuously from the incident angle θ1 to the incident angle θ2 with the azimuthal angle changing from φ to φs as the incident angle crosses zero (normal incidence). When the continuous range of incident angles in an incident plane spans incident angles across normal incidence, the continuous range can be expressed as the union of a range (e.g., 0 to θ1) of incident angles for the azimuthal angle q and a range (e.g., 0 to θ2) of incident angles for the azimuthal angle φs. An optical property, such as optical transmittance, for light incident on the optical film or stack in the incident plane as a function of incident angle can be shown in a same plot for the full range δθ, for example, with the understanding that incident angles on one side of zero incidence angle are for one of φ and φs and incident angles on the opposite side of zero incidence angle are for the other of φ and φs (see, e.g., FIGS. 10A-10B, 15, 16A-16B, and 18). In cases where the optical property if symmetric (e.g., due to a symmetry of a pattern of microstructures) under interchange of φ and φs for a given incident angle, the optical property may be shown in a plot of incident angles on only one side of normal incidence (see, e.g., FIGS. 19A-19B and 23A-24B).

Various optical properties can be determined for one polarization state, for each of two orthogonal polarization states, or for unpolarized light, for example. An s-polarization state 104 and a p-polarization state 105 are schematically illustrated in FIG. 1. An optical stack of the present description may be a mirror or a reflective polarizer, for example.

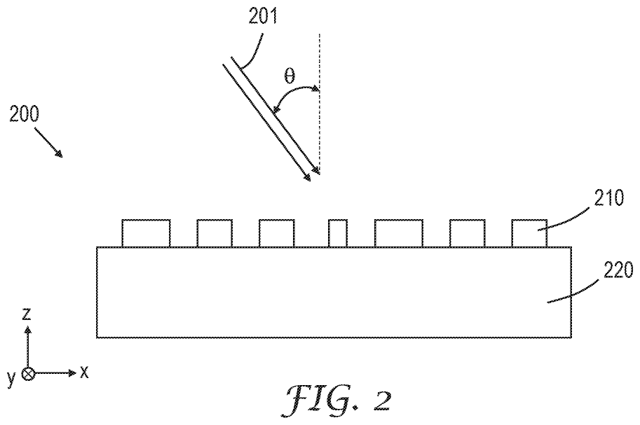

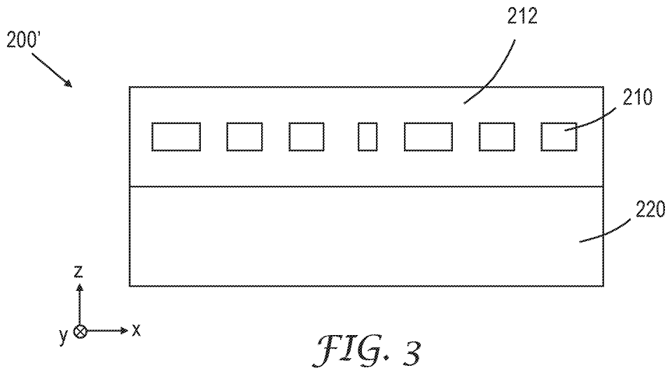

FIGS. 2-3 are schematic cross-sectional views of optical stacks 200, 200′ according to some embodiments. The optical stack 200, 200′ includes a plurality of microstructures 210 arranged on and across an optical film 220. In some embodiments, the plurality of microstructures 210 define a metasurface, for example. A light 201 is incident on the optical stack 200 at an incident angle θ. The light 201 can be substantially collimated (e.g., light 201 can have a divergence/convergence angle having a magnitude of less than about 25, 20, 15, 10, 5, 4 or 3 degrees).

The microstructures 210 can be disposed directly (see, e.g., FIG. 2) or indirectly (see, e.g., FIG. 3) on the optical film 220. For example, the microstructures can be formed directly on an outer layer (e.g., a skin layer) of the optical film or the microstructures can be formed on another layer which can then be disposed on the optical film. In FIG. 3, the microstructures 210 are embedded in a layer 212. In this case, the microstructures 210 can be formed on a first layer and then the microstructures can be backfilled with a backfill material that can be the same or different from the material of the first layer so that the microstructures 210 are embedded between the first layer and the backfill material.

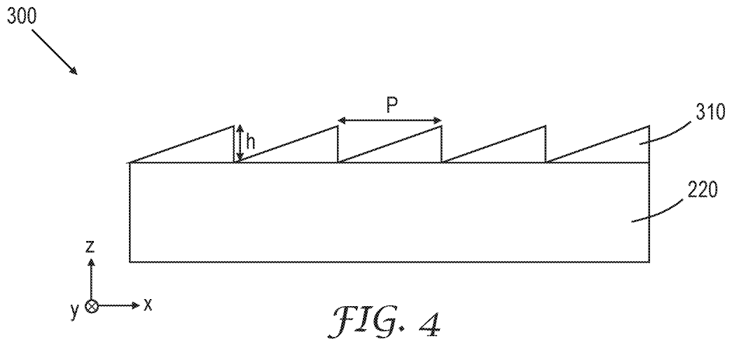

FIG. 4 is a schematic cross-sectional view of an optical stack 300, according to some embodiments. The optical stack 300 includes a plurality of microstructures 310 arranged on and across an optical film 220. The microstructures 310 are arranged along a first direction (x-direction) at a pitch P and have a height h along a thickness direction (z-direction). The microstructures 310 may extend (e.g., linearly) along a second direction (y-direction) orthogonal to the first direction and to the thickness direction, for example. In some embodiments, the plurality of microstructures 310 define a blazed grating, for example. The pitch P can be selected according to the wavelengths desired to be diffracted and the height h can be selected according to the diffraction order(s) for which increased diffraction efficiency is desired. In some embodiments, P is in a range of about 400 nm to about 1200 nm, or about 500 nm to about 1100 nm, or about 600 nm to about 1000 nm, for example. In some embodiments, h is in a range of about 150 nm to about 800 nm, or about 200 nm to about 700 nm, or about 250 nm to about 600 nm, or about 300 nm to about 500 nm, for example.

The microstructures 210, 310, and other microstructures described elsewhere herein can be formed from any suitable material, such as organic (e.g., polymeric) materials or inorganic materials. Polymeric materials are generally materials with a continuous phase of organic polymer. In some embodiments, the microstructures are formed from a material having a refractive index for at least one wavelength in a range of about 400 nm to about 2000 nm of greater than about 1.6, 1.8, 2, or 2.2, for example, and/or can be in a range of about 1.6 to about 2.5, for example. Suitable materials include silver or other metals, Si, SiO₂, TiO₂, or other inorganic oxides, for example. In some embodiments, the optical film includes alternating higher and lower index layers, as described further elsewhere herein. In some embodiments, for at least one wavelength in a range of about 400 nm to about 2000 nm, the refractive index of the microstructures is greater than the refractive index of the lower index layers by at least about 0.1, 0.2, or 0.3, for example. In some embodiments, for at least one wavelength in a range of about 400 nm to about 2000 nm, the refractive index of the microstructures is greater than the refractive index of the higher index layers by at least about 0.1, 0.2, or 0.3, for example. In some embodiments, for at least one wavelength in a range of about 400 nm to about 2000 nm, each of the higher and lower index layers and the microstructures have a refractive index in a range of about 1.4 to about 2.5, for example.

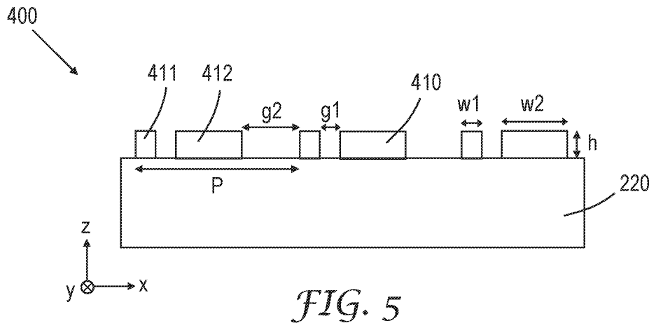

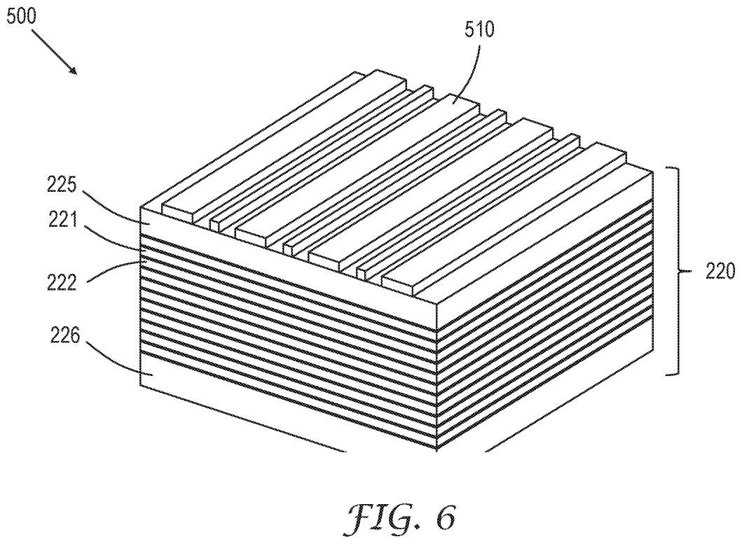

FIG. 5 is a schematic cross-sectional view of an optical stack 400, according to some embodiments. FIG. 6 is a schematic top perspective view of an optical stack 500, according to some embodiments. The optical stack 500 may correspond to some embodiments of the optical stack 400, for example.

Microstructures 410 include first and second microstructures 411 and 412 that may be arranged along a first in-plane direction (x-direction) in a repeating pattern of unit cells arranged at a pitch P where each unit cell include a first microstructure 411 and a second microstructure 412. Such an arrangement may be referred to as a metagrating when the first and second microstructures define a portion of a metasurface. The first and second microstructures 411 and 412 may extend (e.g., linearly) along a second in-plane direction (y-direction) orthogonal to the first in-plane direction and to a thickness direction (z-direction) of the optical stack (e.g., as illustrated in FIG. 6 for microstructures 510). Alternatively, the first and second microstructures 411 and 412 may be localized along the second in-plane direction (e.g., having comparable widths along the y-direction as along the x-direction). The first and second microstructures 411 and 412 have respective widths w1 and w2 along the first in-plane direction and a height h along the thickness direction. Gaps between a first microstructure 411 and adjacent second microstructures on opposite side of the first microstructure 411 are g1 and g2. In some embodiments, g2>g1 and w2>w1. In some embodiments, P is in a range of about 400 nm to about 1200 nm, or about 500 nm to about 1100 nm, or about 600 nm to about 1000 nm, for example. In some embodiments, h is in a range of about 200 nm to about 800 nm, or about 300 nm to about 700 nm, or about 400 nm to about 600 nm, for example. In some embodiments, w1 is in a range of about 50 nm to about 200 nm, or about 60 nm to about 170 nm, or about 70 nm to about 140 nm, for example. In some embodiments, w2 is greater than w1 and no more than about 300, 275, 250, 225 or 200 nm, for example. In some embodiments, w2-w1 is in a range of about 20 nm to about 150 nm, or about 30 nm to about 125 nm, or about 40 nm to about 100 nm, for example. In some embodiments, g1 is in a range of about 50 nm to about 200 nm, or about 60 nm to about 170 nm, or about 65 nm to about 140 nm, for example. In some embodiments, g2 is in a range of g1 to about 700 nm, or g1+about 20 nm to about 600 nm, or g1+about 30 nm to about 500 nm, for example.

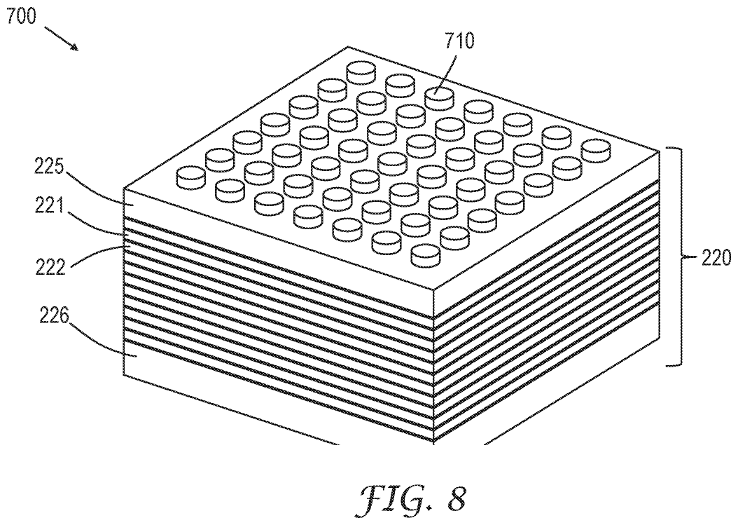

The optical film 220 can include alternating first and second layers 221 and 222 disposed between outer layers 225 and 226 (see, e.g., FIGS. 6 and 8). As is known in the art, optical films including alternating layers can be used to provide desired reflection and transmission in desired wavelength ranges by suitable selection of layer thicknesses and refractive index differences. In some embodiments, the alternating first and second layers 221 and 222 number at least 5, 6, 7, 8, 10, 12, 15, 20, 30, or 50 in total. In some embodiments, the alternating first and second layers 221 and 222 number no more than 1200, 1000, 800, 600, 400, 200, or 100, for example. In some embodiments, each of the first and second layers 221 and 222 has an average thickness less than about 500, 400, 300, 250, or 200 nm. In some embodiments, each of the first and second layers 221 and 222 have an average thickness greater than about 5, 10, 15, or 20 nm, for example. The outer layers 225 and 226 can each have an average thickness greater than about 400, 500, 750, 1000, 1250, 1500, or 2000 nm, for example. The average thickness of each of the outer layers 225 and 226 may be up to about 50, 30, 20, or 10 micrometers, for example.

The first and second layers 221 and 222 can be organic (e.g., polymeric), inorganic, or can be alternating organic and inorganic layers. Generally, utilizing inorganic layers allows a fewer number of layers to be used compared to the case of using only organic (e.g., polymeric) layers due to the typically higher refractive indices available for inorganic materials. Similarly, the outer layers 225 and 226 can be organic (e.g., polymeric), inorganic, or one of the layers can be organic and the other of the layers can be inorganic. Inorganic and organic layers can be deposited using any suitable deposition process such as sputtering or thermal vapor deposition, for example. Useful polymeric materials for the optical film 220 include polyethylene naphthalate (PEN), polyethylene terephthalate (PET), polymethylmethacrylate (PMMA), copolymers thereof, and other polyesters and copolyesters, for example. Polymeric multilayer optical films can be formed by coextrusion followed by stretching, for example. Polymeric multilayer optical films and methods of making polymeric multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); U.S. Pat. No. 9,162,406 (Neavin et al.); and U.S. Pat. No. 11,493,677 (Haag et al.), for example.

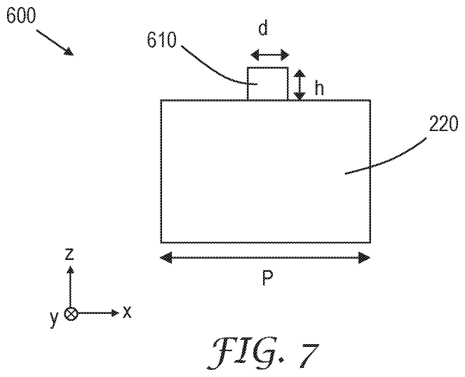

FIG. 7 is a schematic cross-sectional view of a portion 600 of an optical stack, according to some embodiments. FIG. 8 is a schematic top perspective view of an optical stack 700, according to some embodiments. The optical stack 700 may correspond to some embodiments of an optical stack including repeating portions 600, for example. The portion 600 may be repeated along a first in-plane direction (x-direction) at a pitch P. The microstructure 610 has a width d along the first in-plane direction and a height h along a thickness direction (z-direction) of the optical stack orthogonal to the first in-plane direction. The microstructures 610 can extend (e.g., linearly) along a second in-plane direction (y-direction) orthogonal to each of the first in-plane direction and the thickness direction, or can be arranged along the second in-plane direction at a pitch which may be the same or different from the pitch P. The dimension of the microstructures 610 along the second in-plane direction can be about the same as or different from the width d. In FIG. 8, the microstructures 710, which can correspond to the microstructures 610, are arranged on a square lattice. The microstructures 610 can be circular in the x-y plane (see, e.g., FIG. 8) with a diameter d, or square in the x-y plane with a width d, or the microstructures can have other shapes such as rectangles or ellipses, for example. Other lattice geometries may be used. For example, a rectangular lattice or a hexagonal lattice may be used.

In some embodiments, d is in a range of about 30 nm to about 500 nm, or about 40 nm to about 400 nm, or about 50 nm to about 350 nm, for example. In some embodiments, h is in a range of about 10 nm to about 300 nm, or about 12 nm to about 250 nm, or about 14 nm to about 200 nm, or about 16 nm to about 160 nm, for example. In some embodiments, P is in a range of about 80 nm to about 600 nm, or about 100 nm to about 500 nm, or about 110 nm to about 450 nm, for example. In some embodiments, d is in a range of about 200 nm to about 300 nm, h is in a range of about 100 nm to about 200 nm, and P is in a range of about 300 nm to about 450 nm, for example. In some embodiments, d is in a range of about 40 nm to about 100 nm, h is in a range of about 10 nm to about 40 nm, and P is in a range of about 100 nm to about 200 nm, for example.

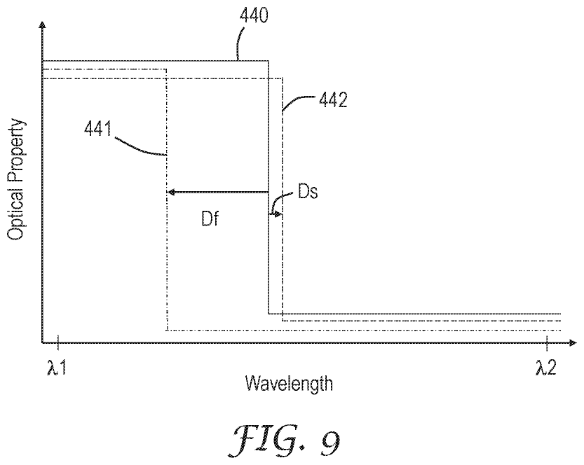

FIG. 9 is a schematic plot of an optical property (e.g., optical transmittance, optical reflectance, optical density) versus wavelength, according to some embodiments. Optical property curve 440 can be for an optical stack or an optical film at substantially normal incidence (though optical properties for the film and stack can differ at substantially normal incidence), optical property curve 441 can be for an optical film for an oblique incident angle (e.g., in a range of about 45 degrees to about 75 degrees), and optical property curve 442 can be for an optical stack at the same oblique incident angle. The optical property can be defined at least over a wavelength range from λ1 to λ2. The wavelength λ1 can be about 380 nm, about 400 nm, or about 420 nm, for example. The wavelength λ2 can be about 2000 nm, about 1500 nm, about 1000 nm, or about 700 nm, for example. Shifts in position of a region where the optical property varies rapidly with wavelength (e.g., band edge) are schematically indicated as Df and Ds for the optical film and optical stack, respectively. Ds can have a substantially smaller magnitude than Df. In some embodiments, Ds and Df are in opposite directions as schematically indicated in FIG. 9, for example. In some embodiments, the optical property of FIG. 9 is an optical transmittance or reflectance defining a reflection band, for example, and a first optical property that is modified by the microstructures is a shift Df, Ds in a band edge of the reflection band. In some embodiments, the optical film has a reflection band extending between first and second band edges of the reflection band. The plurality of microstructures can be configured to primarily change a shift (e.g., reduce and/or change sign) in one of the first and second band edges with increasing incident angle, or the plurality of microstructures can be configured to change a shift (e.g., reduce and/or change sign) in each of the first and second band edges with increasing incident angle.

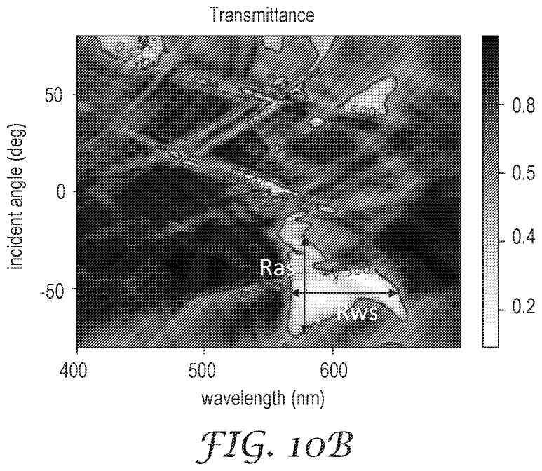

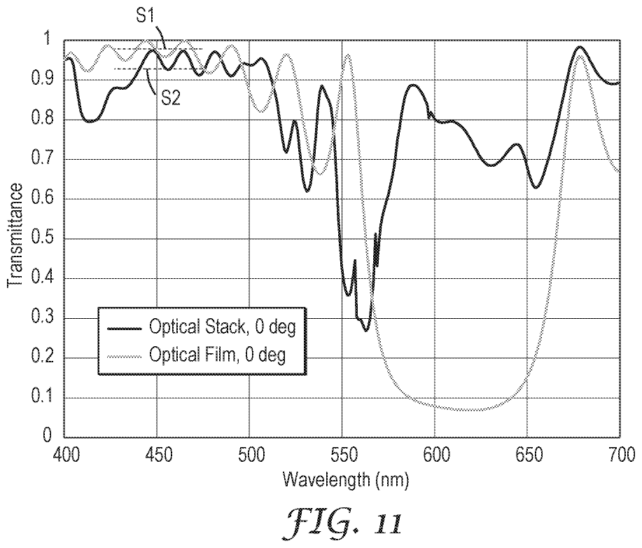

In some embodiments, an optical stack includes a plurality of microstructures arranged on and across an optical film, such that for a range of incident angles at least about 10, 15, 20, 25, or 30 degrees wide, the optical stack and the optical film have a same first optical property over the range of incident angles for light incident on the respective optical stack and optical film for at least a first polarization state and for at least a first wavelength in a predetermined wavelength range extending from about 400 nm to about 2000 nm, where the first optical property varies by respective first and second amounts (e.g., Ds and Df) for the respective optical stack and optical film over the range of incident angles for the first wavelength and the first polarization state, where the plurality of microstructures causes the first amount to be substantially different (e.g., different by greater than about 10%) from the second amount. In some embodiments, at least a same one of an optical transmittance and an optical reflectance of the optical film and optical stack has respective average magnitudes S1 and S2 (see, e.g., FIG. 11) for a first wavelength range for a same incident angle in the range of incident angles, where the first wavelength range is at least about 10 nm wide and lies within the predetermined wavelength range, and where S1 and S2 are within about 20, 15, 10, or 5 percent of each other. In some embodiments, the first optical property of the optical stack and the optical film is or includes a shift of a band edge of a reflection band of the respective optical stack and optical film with increasing incident angle in the range of incident angles, where the band edge of the reflection band for each of the optical stack and the optical film includes a same one of an optical reflectance generally increasing at least from 30% to 70% (or 20% to 80%) with increasing wavelength along the band edge or an optical reflectance generally decreasing at least from 70% to 30% (or 80% to 20%) with increasing wavelength along the band edge. In some embodiments, the first and second amounts are respective first and second shifts in a band-edge wavelength of the band edge of the reflection band of the respective optical stack and optical film when the incident angle of light incident on the respective optical stack and optical film increases from a smallest first to a largest second incident angle in the range of incident angles, where the optical reflectance along the band edge for each of the optical stack and the optical film is about 50% at the band-edge wavelength. In some embodiments, a magnitude (e.g., Ds) of the first amount is at least about 20, 30, 40, 50, 60, or 70% less than a magnitude (e.g., Df) of the second amount. In some embodiments, a band-edge wavelength of the band edge of the reflection band of the optical film decreases when the incident angle of light incident on the optical film increases from a smallest first to a largest second incident angle in the range of incident angles; and a band-edge wavelength of the band edge of the reflection band of the optical stack increases when the incident angle of light incident on the optical film increases from the first to the second incident angle, where for each of the optical stack and the optical film, the optical reflectance along the band edge can be about 50% at the band-edge wavelength.

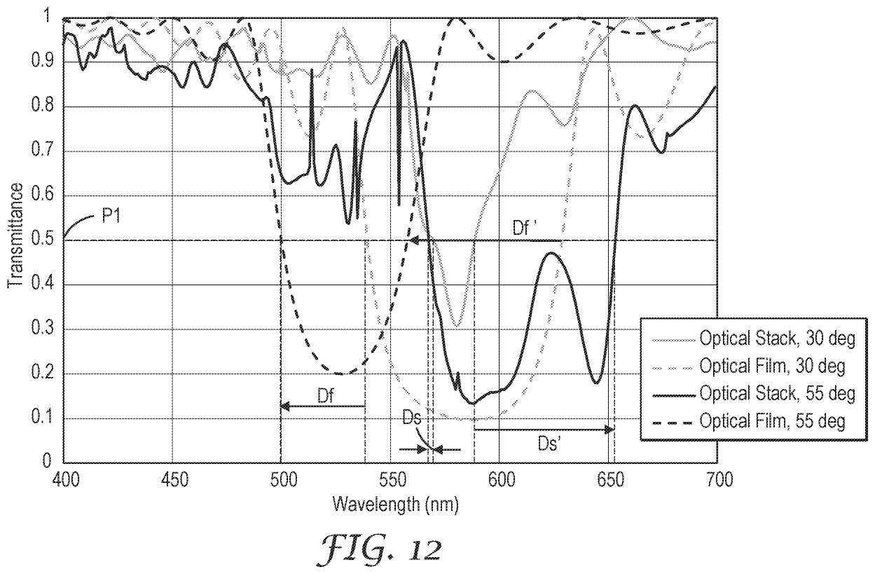

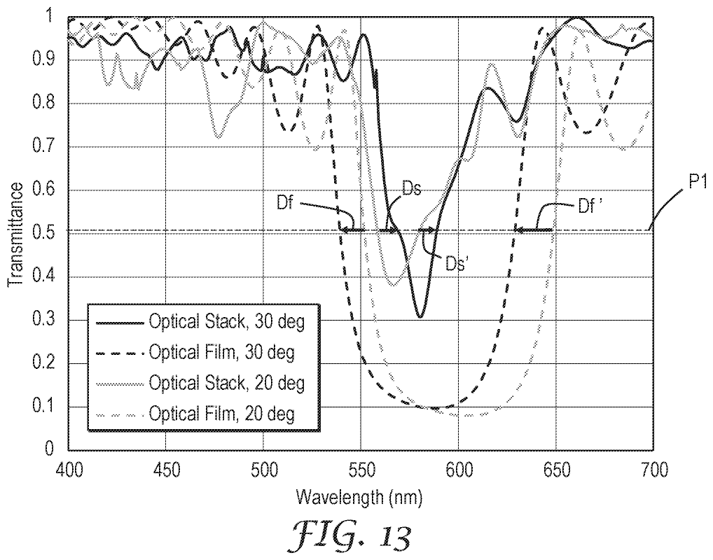

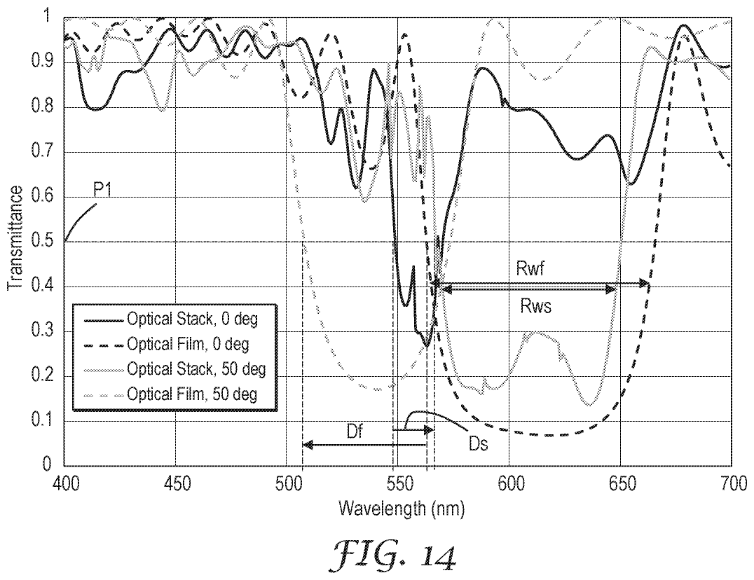

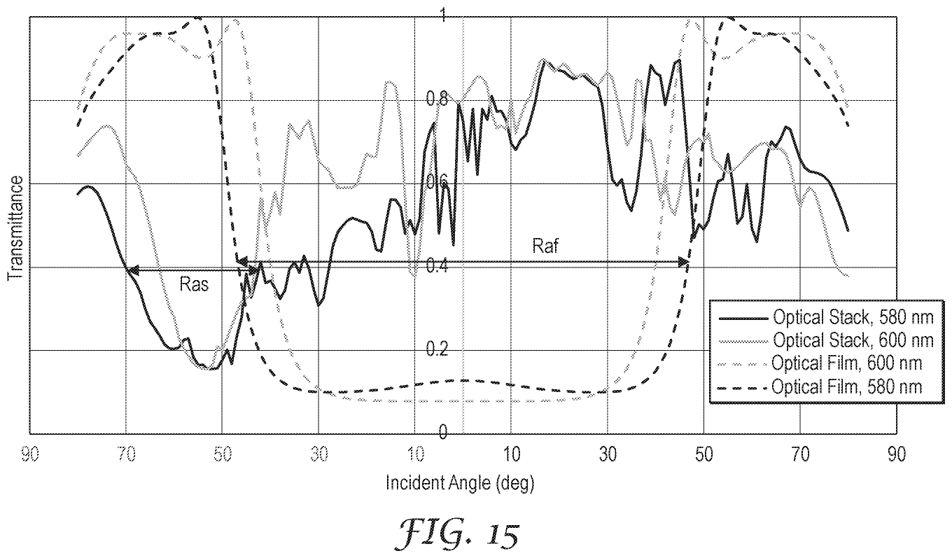

FIGS. 10A-10B are contour plots of optical transmittance of an optical film and optical stack, respectively, as a function of incident angle and wavelength, for p-polarized light, according to some embodiments. Contour lines for a transmittance of 0.5 (or, equivalently, 50%) are shown. Incident angles above and below the incident angle of 0 degrees are for azimuthal angles (measured relative to +x direction) of 0 and 180 degrees, respectively. Largest continuous ranges of incident angle (Raf for the optical film and Ras for the optical stack) and wavelength (Rwf for the optical film and Rws for the optical stack) where the transmittance is less than a predetermined value (0.5, or equivalently, 50% in this case) are schematically indicated. FIGS. 11-14 are plots of optical transmittance versus wavelength for the optical film and stack of FIGS. 10A-10B for various incident angles. The non-zero incident angles in these figures are for an azimuthal angle of 180 degrees. Average values S1, S2 of optical transmittance of the optical film and stack for normally incident light over a wavelength range of 425 nm to 475 nm are indicated in FIG. 11. Shifts Df, Ds in wavelengths where the optical transmittance is P1 (0.5, or equivalently, 50% in this case) when the incident angles shift (from 30 to 55 degrees, in this case) are shown for the optical film and stack, respectively, for a left band edge and corresponding shifts Df′, Ds for a right band edge are shown in FIG. 12. Df, Df′, and Ds are shifts to lower wavelengths and Ds' is a shift to larger wavelengths, in this case. Similarly, shifts Df, Ds, Df′, Ds' are shown in FIG. 13 for an incident angle shift of 20 to 30 degrees and Df, Ds are shown in FIG. 14 for an incident angle shift of 0 to 50 degrees. Also indicated in FIG. 14 are largest continuous ranges of wavelength Rwf and Rws for the respective optical film and stack where the transmittance is less than a predetermined value (about 0.4, or, equivalently, 40% in this case). FIG. 15 is a plot of optical transmittance versus incident angle for the optical film and stack of FIGS. 10A-10B for various wavelengths. Incident angles to the right and left of the incident angle of 0 degrees are for azimuthal angles of 0 and 180 degrees, respectively. Largest continuous ranges of incident angle Raf and Ras for the respective optical film and stack where the transmittance is less than a predetermined value (about 0.4, or, equivalently, 40% in this case) are indicated in FIG. 15.

The plots of FIGS. 10A-15 were generated using standard optical modeling techniques for a blazed grating including microstructures 310 appearing generally as schematically illustrated in FIG. 4 disposed on an optical film 220 appearing generally as schematically illustrated in FIG. 6 or 8. In the modeled example, the microstructures 310 had a height h of 400 nm and were arranged at a pitch P of 744 nm; and the optical film 220 included 11 pairs of higher and lower index layers (corresponding to layers 221 and 222) modeled as a quarter-wave stack reflector with a design wavelength of 610 nm. The higher index layers had a refractive index of 1.8 (approximate index of sapphire, aluminum oxynitride, or some high index resins, for example) and the lower index layers, as well as outer layers 225 and 226, had a refractive index of 1.5 (approximate index of PMMA, for example). The microstructures 310 had a refractive index of 2.4. The outer layer 225, which separated the microstructures 310 from the pairs of higher and lower index layers, had a thickness of 500 nm. It will be understood that other refractive indices, total layer number, and dimensions h and P may alternatively be utilized.

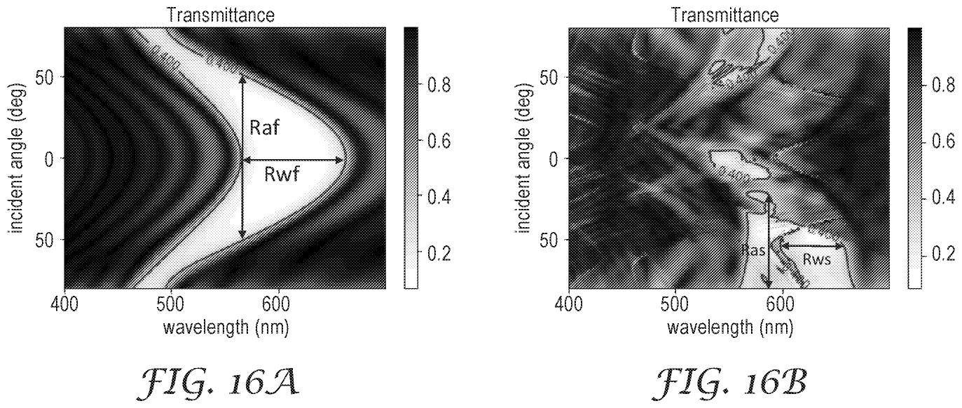

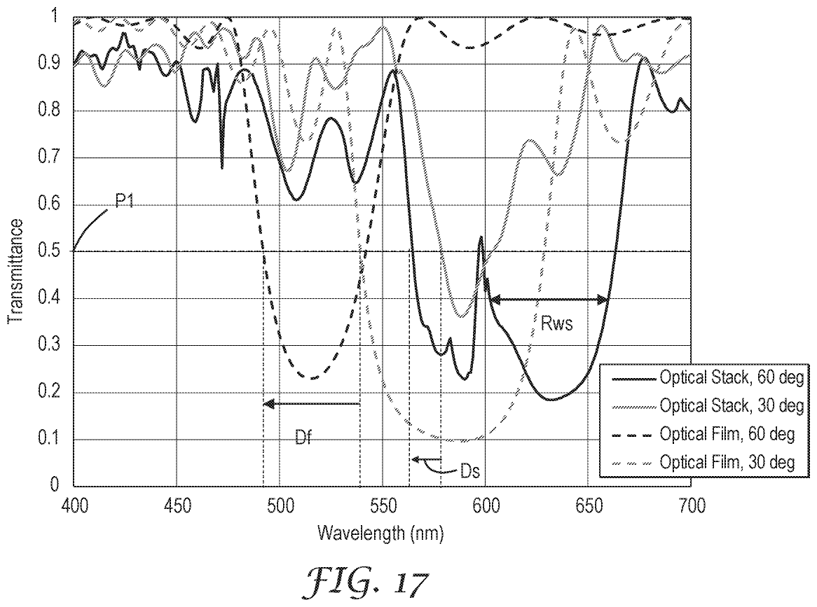

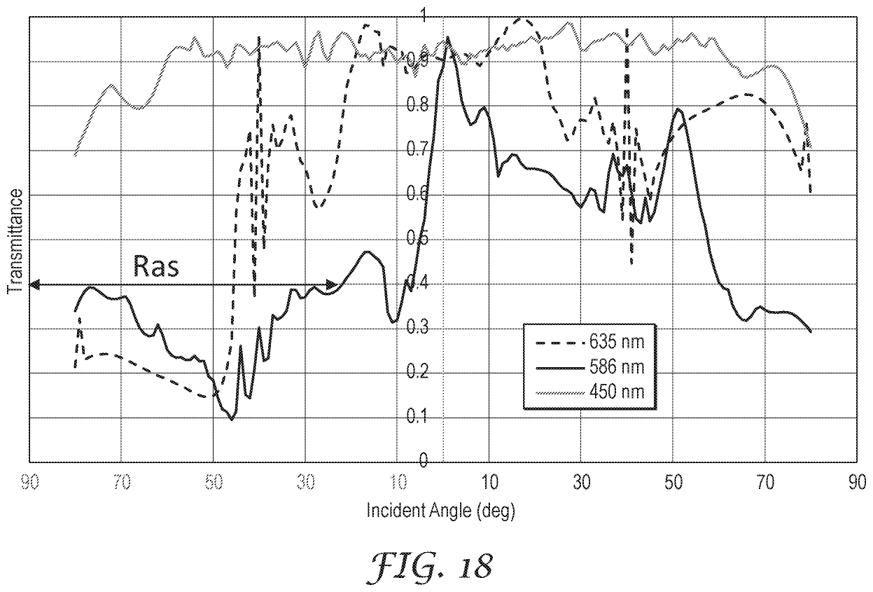

FIGS. 16A-16B are contour plots of optical transmittance of an optical film and optical stack, respectively, as a function of incident angle and wavelength, for p-polarized light, according to some embodiments. Contour lines for a transmittance of 0.4 (or, equivalently, 40%) are shown. Incident angles above and below the incident angle of 0 degrees are for azimuthal angles (measured relative to +x direction) of 0 and 180 degrees, respectively. Largest continuous ranges of incident angle (Raf for the optical film and Ras for the optical stack) and wavelength (Rwf for the optical film and Rws for the optical stack) where the transmittance is less than a predetermined value (0.4 in this case) are schematically indicated. FIG. 17 is a plot of optical transmittance versus wavelength for the optical film and stack of FIGS. 16A-16B for various incident angles. Shifts Df, Ds in wavelengths where the optical transmittance is P1 (about 0.5 in this case) when the incident angles shift (from 30 to 60 degrees in this case) are shown for the optical film and stack, respectively, for a left band edge. The non-zero incident angles in these figures are for an azimuthal angle of 180 degrees. FIG. 18 is a plot of optical transmittance versus incident angle for the optical stack of FIG. 16B for various wavelengths. Incident angles to the right and left of the incident angle of 0 degrees are for azimuthal angles of 0 and 180 degrees, respectively. The largest continuous ranges of incident angle Ras for the optical tack where the transmittance is less than a predetermined value (about 0.4 in this case) is indicated in FIG. 18.

The plots of FIGS. 16A-18 were generated using standard optical modeling techniques for a metagrating including microstructures 410 appearing generally as schematically illustrated in FIGS. 5-6 disposed on an optical film 220 appearing generally as schematically illustrated in FIG. 6 or 8. In the modeled example, the microstructures 410 had a height h of 513 nm and included first and second microstructures 411 and 412 arranged in unit cells at a pitch P of 744 nm; and the optical film 220 included 11 pairs of higher and lower index layers as described for FIGS. 10A-10B. The microstructures 410 had a refractive index of 2.4. The widths w1 and w2 were 106 nm and 176 nm, respectively. The gap g1 was 102 nm. It will be understood that other refractive indices, total layer number, and dimensions h, P, w1, w2, and g1 may alternatively be utilized.

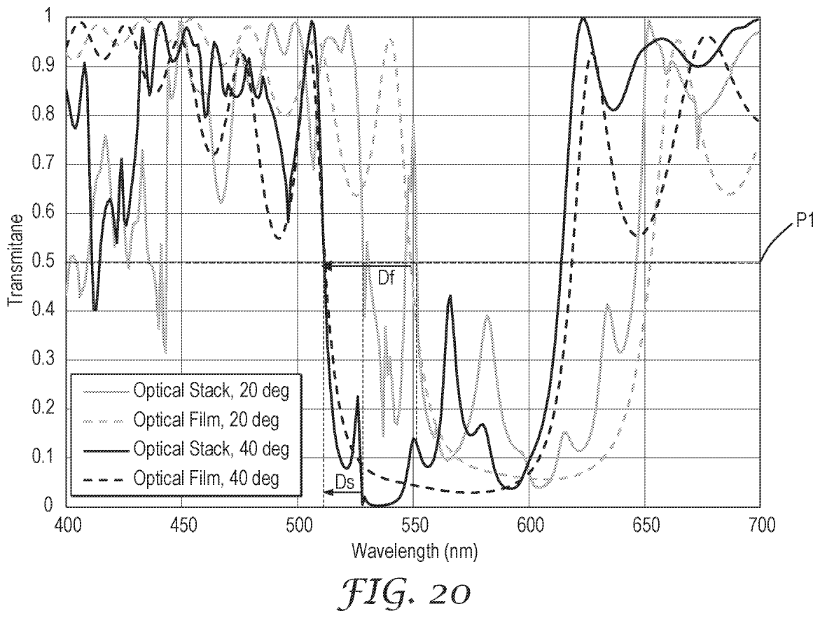

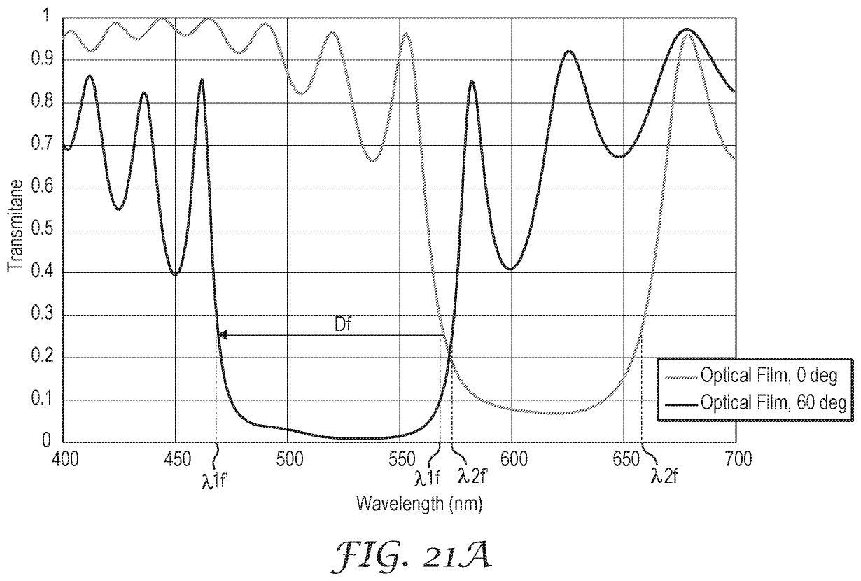

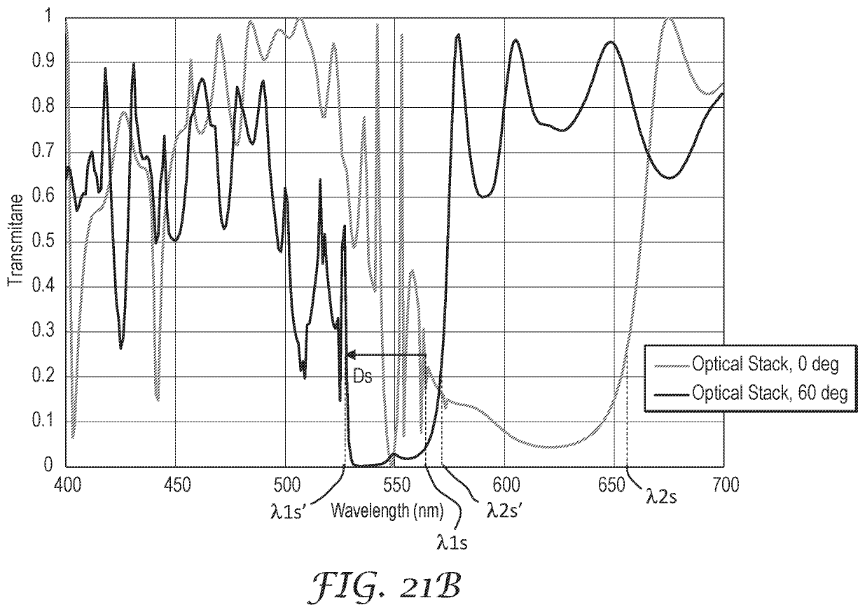

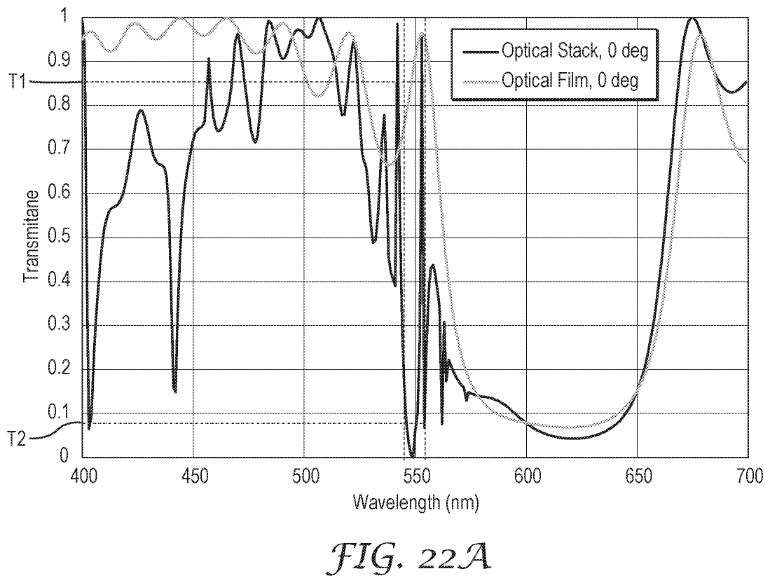

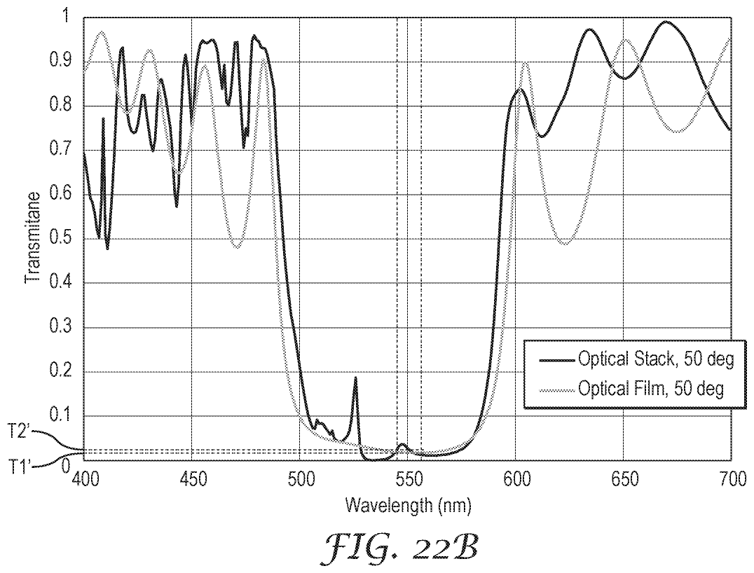

FIGS. 19A-19B are contour plots of optical transmittance of an optical film and optical stack, respectively, as a function of incident angle and wavelength, for s-polarized light, according to some embodiments. Contour lines for a transmittance of 0.25 (or, equivalently, 25%) are shown. FIG. 20 is plot of optical transmittance versus wavelength for the optical film and stack of FIGS. 19A-19B for various incident angles. Shifts Df, Ds in wavelengths where the optical transmittance is P1 (about 0.5, or, equivalently, 50% in this case) when the incident angles shifts from 20 to 40 degrees, in this case, are shown for the optical film and stack, respectively, for a left band edge. FIGS. 21A-21B are plots of optical transmittance versus wavelength for the optical film and stack, respectively, of FIGS. 19A-19B for incident angles of 0 degrees and 60 degrees. Largest continuous ranges where the optical transmittance is no greater than about 25% are indicated as ranges from λ1f to λ2f for the optical film at a first incident angle (0 degrees, in this case), from λ1f to λ2f for the optical film at a second incident angle (60 degrees, in this case) larger than the first incident angle, from λ1s to λ2s for the optical stack at the first incident angle, and from λ1s′ to λ2s′ for the optical stack at the second incident angle. Respective shifts Df and Ds from λ1f to λ1f′ and from λ1s to λ1s′ are schematically indicated. FIGS. 22A-22B are plots of optical transmittance versus wavelength for the optical film and stack of FIGS. 19A-19B for incident angles of 0 degrees and 50 degrees, respectively. Average optical transmittances T1 and T2 for the respective optical film and stack in a wavelength range (around 550 nm, in this case) for a first incident angle (0 degrees, in this case) and average optical transmittances T1′ and T2′ for the respective optical film and stack in the same wavelength range for a second incident angle (50 degrees, in this case) are indicated.

The plots of FIGS. 19A-22B were generated using standard optical modeling techniques for a dielectric metasurface including microstructures 610 appearing generally as schematically illustrated in FIGS. 7-8 disposed on an optical film 220 appearing generally as schematically illustrated in FIG. 6 or 8. In the modeled example, the microstructures 610 were modeled as TiO₂ nanodisks having a refractive index of 2.4 and a height h of 148 nm and that were arranged on a square lattice with a pitch P of 361 nm; and the optical film 220 included 11 pairs of higher and lower index layers as described for FIGS. 10A-10B. It will be understood that other refractive indices, total layer number, and other dimensions h and P may alternatively be utilized.

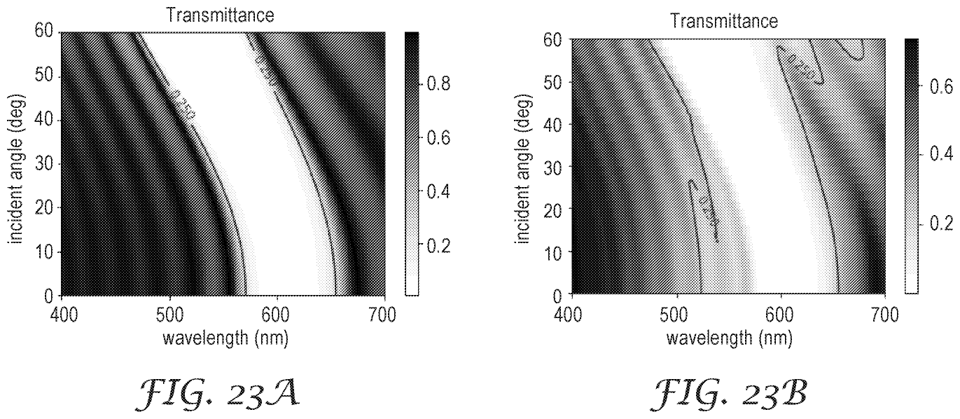

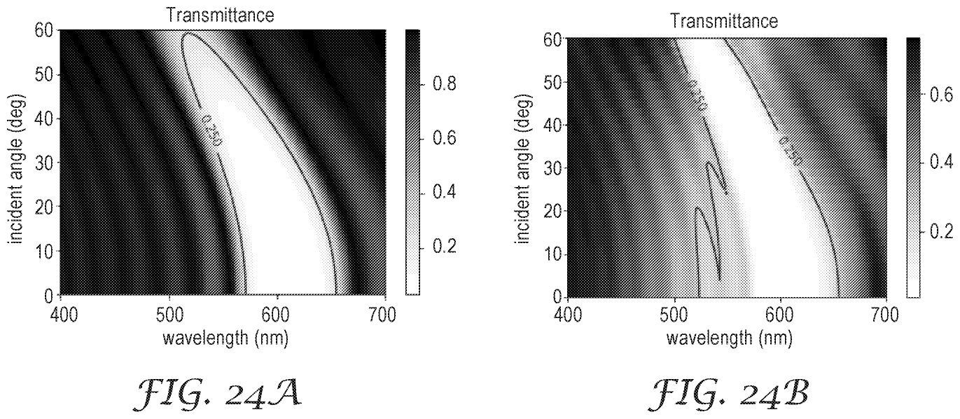

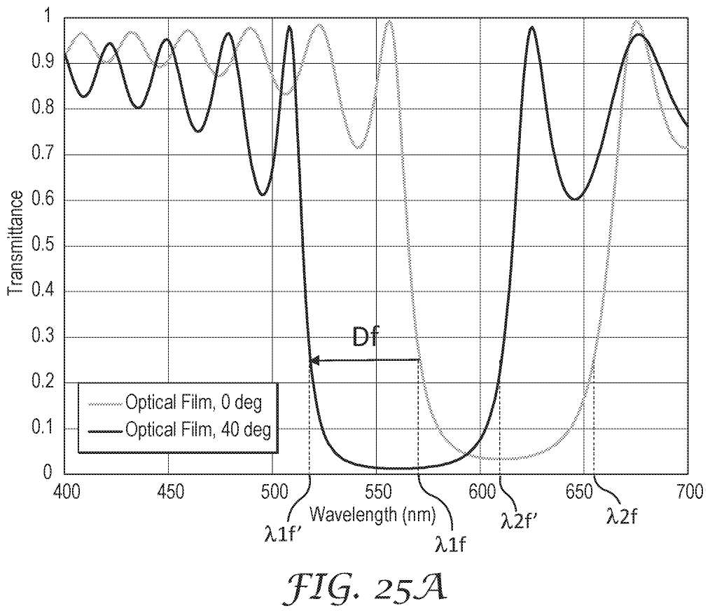

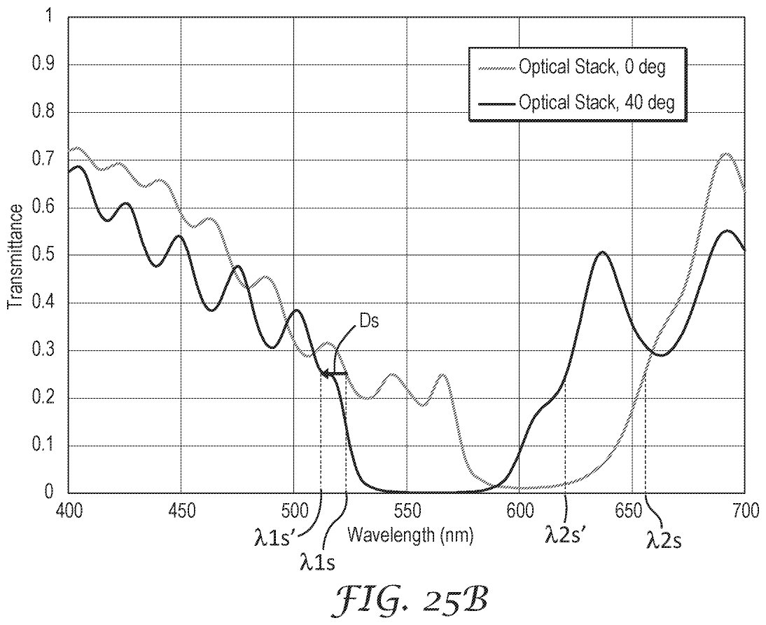

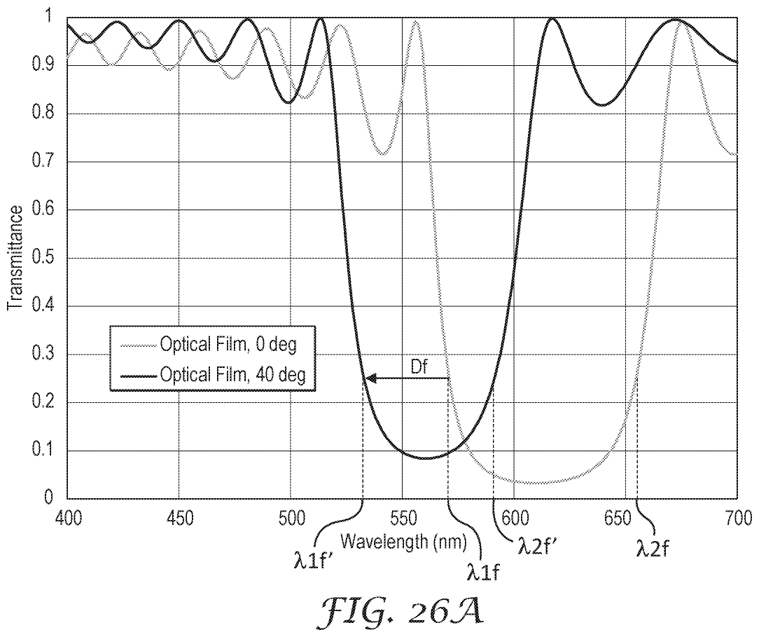

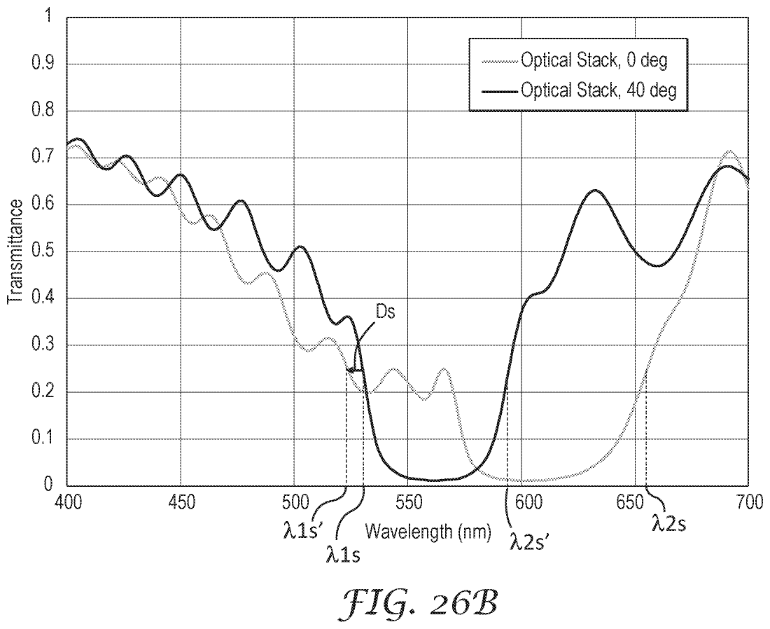

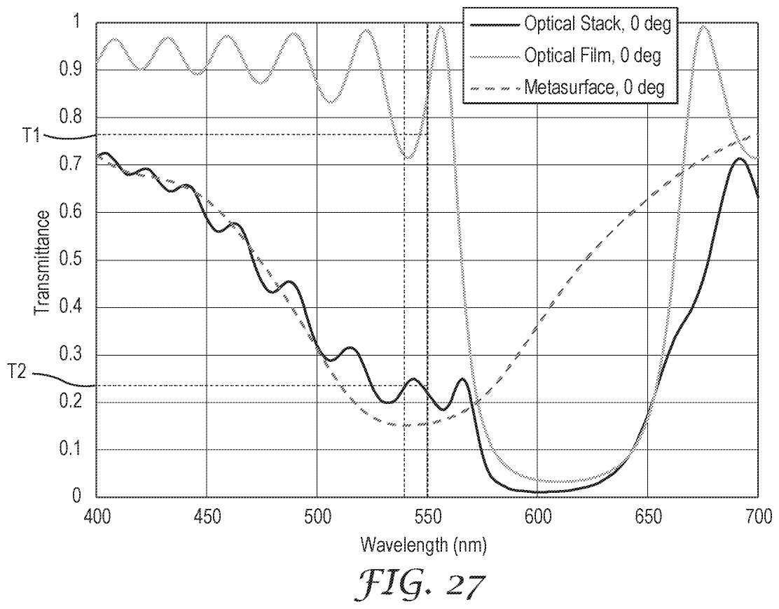

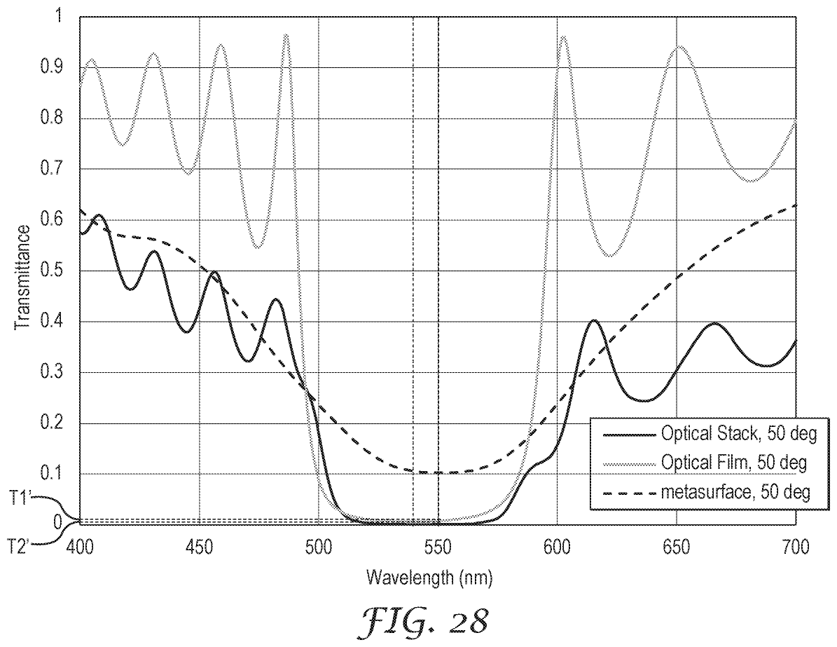

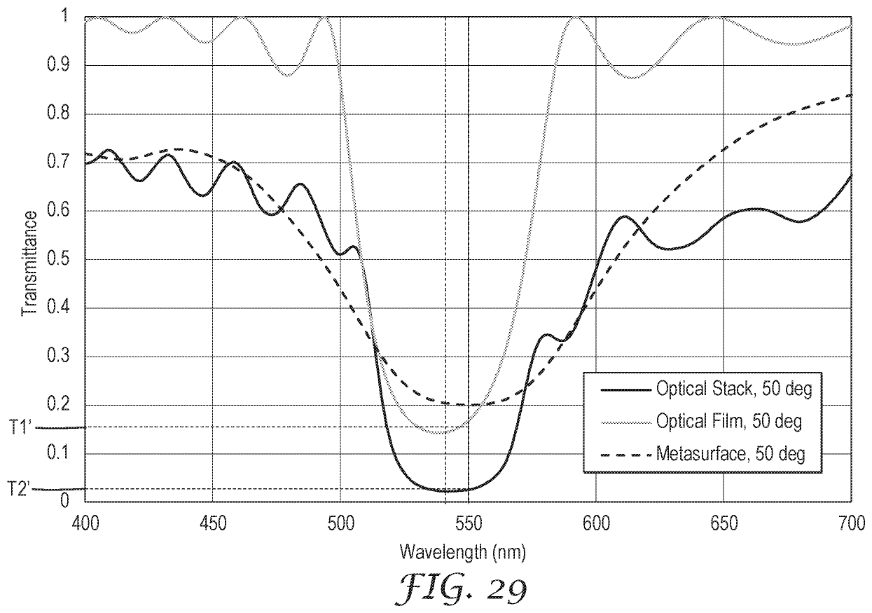

FIGS. 23A-23B are contour plots of optical transmittance of an optical film and optical stack, respectively, as a function of incident angle and wavelength, for s-polarized light, according to some embodiments. FIGS. 24A-24B are contour plots of optical transmittance of the optical film and optical stack, respectively, of FIGS. 23A-23B as a function of incident angle and wavelength, for p-polarized light, according to some embodiments. Contour lines for a transmittance of 0.25 (or, equivalently, 25%) are shown in each of FIGS. 23A-24B. FIGS. 25A-25B are plots of optical transmittance versus wavelength for the optical film and stack, respectively, of FIGS. 23A-23B for incident angles of 0 degrees and 40 degrees and for s-polarized incident light. FIGS. 26A-26B are plots of optical transmittance versus wavelength for the optical film and stack, respectively, of FIGS. 24A-24B for incident angles of 0 degrees and 40 degrees and for p-polarized incident light. Largest continuous ranges where the optical transmittance is no greater than about 25% are indicated as ranges from λ1f to λ2f for the optical film at a first incident angle (0 degrees, in this case), from λ1f to λ2f′ for the optical film at a second incident angle (40 degrees, in this case) larger than the first incident angle, from λ1s to λ2s for the optical stack at the first incidence angle, and from λ1s′ to λ2s′ for the optical stack at the second incident angle. Respective shifts Df and Ds from λ1f to λ1f and from λ1s to λ1s′ are schematically indicated. FIG. 27 is a plot of optical transmittance versus wavelength for the optical film, optical stack, and plurality of microstructures (the metasurface, in this case) of FIGS. 23A-24B for an incident angle of 0 degrees. FIG. 28 is a plot of optical transmittance versus wavelength for the optical film, optical stack, and plurality of microstructures of FIGS. 23A-23B for an incident angle of 50 degrees for s-polarized incident light. FIG. 29 is a plot of optical transmittance versus wavelength for the optical film, optical stack, and plurality of microstructures of FIGS. 24A-24B for an incident angle of 50 degrees for p-polarized incident light. Average optical transmittances T1 and T2 for the respective optical film and stack in a wavelength range (around 550 nm, in this case) for a first incident angle (0 degrees, in this case) and average optical transmittances T1′ and T2′ for the respective optical film and stack in the same wavelength range for a second incident angle (50 degrees, in this case) are indicated.

The plots of FIGS. 23A-29 were generated using standard optical modeling techniques for a plasmonic metasurface including microstructures 610 appearing generally as schematically illustrated in FIG. 7 disposed on an optical film 220 appearing generally as schematically illustrated in FIG. 6 or 8. In the modeled example, the microstructures 610 were modeled as silver nanopatches (squares in top plan view) having a width d of 70 nm, a height h of 20 nm and that were arranged on a square lattice with a pitch P of 140 nm; and the optical film 220 included 11 pairs of higher and lower index layers as described for FIGS. 10A-10B. The dimensions of the silver nanopatches were selected so that the metasurface was reflective at wavelengths around 550 nm while being significantly transparent otherwise (see, e.g., FIG. 27). It will be understood that other materials, total layer number and/or dimensions may alternatively be utilized (e.g., when reflection in different wavelength ranges are desired).

In some embodiments, an optical stack 200, 200′, 300, 400, 500, 600, 700 includes a plurality of microstructures 210, 310, 410, 510, 610, 710 arranged on and across an optical film 220, such that for a substantially collimated incident light, a same first polarization state 104 or 105, a same first optical property, and a same first wavelength range that is at least about 10 nm wide and lies within a predetermined wavelength range extending from about 400 nm to about 2000 nm, the first optical property of the optical film and stack have respective average magnitudes S1 and S2 (see, e.g., FIG. 11 where the illustrative first optical property is optical transmittance) in the first wavelength range for a same incident angle of less than about 10 degrees, where S1 and S2 are within about 20% of each other; and for a first incident angle and a second incident angle that is greater than the first incident angle by at least about 10 degrees, the first optical property of each of the optical film and stack remains within about 20, 15, 10, 5, 4, 3, 2, 1% of a same P1 (see, e.g., FIGS. 12-14, 17, 20), P1≥0.3 S1, as incident angle and wavelength of the incident light change from the first incident angle at a first wavelength (e.g., indicated by the non-arrow end of the arrows for Df, Ds, Df′, or Ds′) to the second incident angle at a second wavelength (e.g., indicated by the arrow end of the arrows for Df, Ds, Df, or Ds′). In some embodiments, a magnitude of a difference between the first and second wavelengths is greater for the optical film than for the optical stack by at least about 10, 20, 30, 50, 70, 90, or 100%. The magnitude of the difference can be up to about 1000, 5000, or 10000 percent, for example, or even higher since Ds or Ds' can be very (e.g., arbitrarily) small. For example, Df may be about 120 nm and Ds may be about 2 nm so that Df is about 5900% ([120−2]/2×100%) greater for the optical film than the optical stack. In some embodiments, Df/Ds and/or Df′/Ds' is at least about 2, 3, 4, or 5, for example. In some embodiments, differences between the first and second wavelengths (i.e., the first wavelength minus the second wavelength) for the optical film and stack have opposite signs (see, e.g., at least FIGS. 9 and 13-14). For example, in some embodiments, for the optical film, the first wavelength is greater than the second wavelength by at least about 5 nm; and for the optical stack, the second wavelength is greater than the first wavelength by at least about 1 nm. In some embodiments, for the optical film, the first wavelength is greater than the second wavelength by at least about 10, 15, 20, or 25 nm. In some embodiments, for the optical stack, the second wavelength is greater than the first wavelength by at least about 2, 4, 6, 8, 10, 12, or 15 nm. In some embodiments, for the optical film, the first wavelength is greater than the second wavelength by about 10 nm to about 200 nm; and for the optical stack, the second wavelength is greater than the first wavelength by at least about 2 nm to about 100 nm, for example. In some embodiments, for each of the optical stack and film, the first and second wavelengths are each in the predetermined wavelength range.

The first wavelength range can be at least about 10, 20, 30, 40, or 50 nm wide, for example. The first wavelength range may be up to about 300, 200, 150, or 100 nm wide, for example. For example, in FIG. 11, optical transmittance (a first optical property) having average magnitudes S1 (about 0.97) and S2 (about 0.93) are illustrated for a wavelength range of 425 nm to 475 nm. The first incident angle can be 0 degrees or can be greater than about 5, 10, 15, 20, or 25 degrees, for example. The second incident angle can be greater than the first incident angle by at least about 10, 15, 20, 25, or 30 degrees, for example.

In some embodiments, the optical film 220 is a mirror film having an average optical reflectance greater than about 60, 70, 80, or 90 percent in a second wavelength range within the predetermined wavelength range for substantially normally incident light for each of two mutually orthogonal polarization states. In some embodiments, the optical film 220 is a reflective polarizer having an average optical reflectance greater than about 60, 70, 80, or 90 percent in a second wavelength range within the predetermined wavelength range for substantially normally incident light for the first polarization state and an average optical transmittance greater than about 60, 70, 80, or 90 percent in the wavelength range within the predetermined wavelength range for substantially normally incident light for a second polarization state orthogonal to the first polarization state. The second wavelength range can be at least about 10, 20, 30, 40, 50, 75, 100, 150, or 200 nm wide, for example. The second wavelength range may be up to about 2000, 1600, 1200, or 800 nm, for example.

When wavelength and incident angle change from a first incident angle at a first wavelength to a second incident angle at a second wavelength, the change in wavelength and the change in incident angle should be understood to be continuous changes (e.g., along a same one of a left band edge and a right band edge). In some embodiments, the change in incident angle, is a continuous, monotonic change in incident angle. In some embodiments, the change in wavelength, is a continuous change in wavelength that may be a continuous, monotonic change or that may be a continuous, non-monotonic change. The change in wavelength and incident angle should be understood to be at a constant azimuthal angle.

In some embodiments, the first optical property is optical transmittance. In some embodiments, for each of the optical stack and the optical film and for each of the first incident angle at the first wavelength and the second incident angle at the second wavelength, the optical transmittance decreases with increasing wavelength (e.g., corresponding to a left band edge of a reflection band which may be indicated in the figures by Df or Ds). In some embodiments, for each of the optical stack and the optical film and for each of the first incident angle at the first wavelength and the second incident angle at the second wavelength, the optical transmittance increases with increasing wavelength (e.g., corresponding to a right band edge of a reflection band which may be indicated in the figures by Df′ or Ds′). In some embodiments, the first optical property is optical reflectance.

In some embodiments, |S1−S2|<0.2, 0.15, 0.1, or 0.05. In some embodiments, 0.7 S1≥P1. In some embodiments, 0.65 S1≥P1≥0.35 S1, or 0.6 S1≥P1≥0.4 S1, or 0.55 S1≥P1≥0.45 S1. In some embodiments, 0.7≥P1≥0.3, or 0.65≥P1≥0.35, or 0.6≥P1≥0.4, or 0.55≥P1≥0.45. In some embodiments, the first optical property is optical transmittance or optical reflectance and P1 is about 0.5.

In some embodiments, the magnitude of the difference between the first and second wavelengths for the optical film is greater than about 20 nm and the magnitude of the difference between the first and second wavelengths for the optical stack is less than about 10 nm. In some embodiments, the magnitude of the difference between the first and second wavelengths for the optical film is greater than about 25, 30, or 35 nm, for example, and may be up to about 300 nm, for example. In some embodiments, the magnitude of the difference between the first and second wavelengths for the optical stack is less than about 9, 8, 7, 6, or 5 nm. In some embodiments, the magnitude of the difference between the first and second wavelengths is greater for the optical film than for the optical stack by at least a factor of about 2, 3, 4, 5, 6, 7, or 8.

In some embodiments, an optical stack 200, 200′, 300, 400, 500, 600, 700 includes a plurality of microstructures 210, 310, 410, 510, 610, 710 arranged on and across an optical film 220, such that for a substantially collimated incident light, a same first polarization state 104 or 105, for a same first wavelength range that is at least about 5 nm wide and lies within a predetermined wavelength range extending from about 400 nm to about 2000 nm, and for first and second incident angles differing from one another by at least about 30 degrees, where one of the first and second incident angles less than about 10 degrees: the optical film and optical stack have respective average optical transmittances T1 and T2 in the first wavelength range for the first incident angle, where T1 is greater than about 65% and T2 is less than about 40%; and the optical film and optical stack have respective average optical transmittances T1′ and T2′ in the first wavelength range for the second incident angle, where each of T1′ and T2′ less than about 25, 24, 23, 22, 21, 20, 19, 18, 17, or 16%. In some embodiments, T1 is greater than about 66, 67, 68, 69, 70, 71, 72, 73, 74, or 75%. In some embodiments, T2 is less than about 38, 36, 34, 32, 30, 28, 26, or 24%. In some embodiments, T1-T2 is greater than about 30%, 35%, 40%, or 45%, and each of each of T1′ and T2′ is less than about 20%. In some embodiments, each of T1′ and T2′ is less than about 24, 23, 22, 21, 20, 19, 18, 17, or 16%. In some embodiments, at least one of T1′ and T2′ is less than about 15, 14, 13, 12, 11, 10, 9, 8, 7, 6, 5, 4, or 3%. In some embodiments, the first wavelength range is at least about 6, 7, 8, 9, or 10 nm wide. In some embodiments, the width of the first wavelength range is in a range of about 5 nm to about 30, 25, 20, 15, or 10 nm, for example.

Average optical transmittances for various illustrative optical films and stacks, according to some embodiments, are provided in the following table.

| | | Incident | | | | |
|---|---|---|---|---|---|---|
| | Wavelength | angles | | | | |
| | Range (nm) | (deg) | T1 | T2 | T1′ | T2′ |
| FIGS. | 548-555 | 0, 50 | 85.9% | 8.91% | 1.96% | 2.88% |
| 22A-22B | | | | | | |
| FIGS. 27 | 540-550 | 0, 50 | 75.7% | 23.9% | 0.78% | 0.11% |
| and 28 | | | | | | |
| FIGS. 27 | 540-550 | 0, 50 | 75.7% | 23.9% | 15.3% | 2.34% |
| and 29 | | | | | | |

In some embodiments, an optical stack 200, 200′, 300, 400, 500, 600, 700 includes a plurality of microstructures 210, 310, 410, 510, 610, 710 arranged on and across an optical film 220, such that for a substantially collimated incident light 201, for a same first polarization state 104 or 105, for a predetermined wavelength range extending from about 400 nm to about 2000 nm, and for a first incident angle less than about 10 degrees and a second incident angle greater than the first incident angle by at least about 30 degrees, optical transmittance of each of the optical stack and film defines a largest continuous range of wavelength that lies within the predetermined wavelength range where the optical transmittance is no greater than about 25%. The largest continuous range of wavelength extending from a shorter first wavelength λ1f, λ1s, λ1f′, λ1s′ to a longer second wavelength λ2f, λ2s, λ2f′, λ2s′ (see, e.g., FIGS. 21A-21B and 25A-26B. Here, f and s indicate film and stack, respectively, and the prime indicates the second incident angle).

In some embodiments, for at least a same one of the first and second wavelengths, a magnitude of a difference between the wavelength at the first incident angle and the wavelength at the second incident angle is greater for the optical film (e.g., Df) than for the optical stack (e.g., Ds) by at least about 10, 20, 30, 50, 70, 90, or 100%. The magnitude of the difference can be up to about 1000, 5000, or 10000 percent, for example, or even higher since Ds, for example can be very (e.g., arbitrarily) small.

In some embodiments, the largest continuous range of wavelength where the optical transmittance is no greater than about 25% defines a reflection band having a fractional bandwidth of at least about 1, 2, 3, 4, 5%, for example. In some embodiments, for the optical film and for at least one of the first and second incident angles, a difference between the second and first wavelengths (e.g., λ2f−λ1f) is at least about 1, 2, 3, 4, 5% of an average of the first and second wavelengths (e.g., (λ2f+λ1f)/2).

In some embodiments, for the optical film and for at least a same one of the first and second wavelengths, a magnitude of a difference in the wavelength for the first and second incident angles is greater than about 5, 10, 15, 20, 25, 30, 35, 40, 45, 50, 60, 70, 80, or 90 nm. The magnitude of this difference can be up to about 300, 250, 200, 150, or 100 nm, for example. In some embodiments, for the optical film, the first wavelength λ1f at the first incident angle is greater than the first wavelength λ1f at the second incident angle by at least about 5, 10, 15, 20, 25, 30, 35, 40, 45, or 50 nm. In some embodiments, λ1f-λ1f is in a range of about 10 nm to about 300, 250, 200, 150, or 100 nm, for example. Similarly, λ2f-λ2f′ can be at least about 5, 10, 15, 20, 25, 30, 35, 40, 45, or 50 nm and/or can be a range of about 10 nm to about 300, 250, 200, 150, or 100 nm, for example. In some embodiments, for the optical stack and for at least one of the first and second wavelengths, a magnitude of a difference in the wavelength for the first and second incident angles is less than about 50, 45, 40, 35, 30, 25, 20, 15, 10, or 5 nm, for example.

In some embodiments, an optical stack 200, 200′, 300, 400, 500, 600, 700 includes a plurality of microstructures 210, 310, 410, 510, 610, 710 arranged on and across an optical film 220, such that for a substantially collimated incident light 201, for a same first polarization state 104 or 105, and for a same first incident plane (e.g., x-z plane), optical transmittances of the optical stack and the optical film as a function of incident angle and wavelength of the incident light define a largest continuous region of incident angle and wavelength within a predetermined wavelength range extending from about 400 nm to about 2000 nm where the optical transmittance is less than a same first transmittance. The largest continuous region can be at least about 10, 20, 30, 50, 70, 90, or 100% larger for the optical film than for the optical stack, for example. The largest continuous region can be up to about 700, 500, 300, or 200% larger for the optical film than for the optical stack, for example. Here, the size of the largest continuous region is a total area of the largest continuous region in a (e.g., contour) plot of transmittance versus incident angle and wavelength. In some embodiments, an optical stack 200, 200′, 300, 400, 500, 600, 700 includes a plurality of microstructures 210, 310, 410, 510, 610, 710 arranged on and across an optical film 220, such that for a substantially collimated incident light 201, for a same first polarization state 104 or 105, and for a same first incident plane (e.g., x-z plane), and for a predetermined wavelength range extending from about 400 nm to about 2000 nm, for a largest continuous range of incident angle Raf, Ras (see, e.g., FIGS. 10A-10B, 15, 16A-16B, and 18) at a constant wavelength in the predetermined wavelength range, and a largest continuous range of wavelength Rwf, Rws (see, e.g., FIGS. 10A-10B, 14, 16A-16B, and 17) that lies within the predetermined wavelength range at a constant incident angle, where optical transmittances of the optical stack and the optical film are each less than a same first transmittance. In some embodiments, at least one of the continuous range of wavelength and the continuous range of incident angle is at least about 10, 20, 30, 50, 70, or 90% larger for the optical film than for the optical stack. In some embodiments, each of the continuous range of wavelength and the continuous range of incident angle is at least about 10, 20, 30, 50, 70, or 90% larger for the optical film than for the optical stack. At least one, or each, of the continuous range of wavelength and the continuous range of incident angle can be up to about 500, 300, or 200% larger for the optical film than for the optical stack, for example. The first transmittance can be in a range of about 25% to about 55%, or about 30% to about 50%, for example. In some embodiments, the first transmittance is about 40% or about 50%. For example, the first transmittance can correspond to the 0.5 (50%) transmittance contours of FIGS. 10A-10B, or the 0.4 (40%) transmittance contours of FIGS. 16A-16B.

The largest continuous region of incident angle and wavelength can be limited to wavelengths within the predetermined wavelength range extending from about 400 nm to about 2000 nm. Other limitations may alternatively be used. For example, optical transmittances of the optical stack and the optical film as a function of incident angle and wavelength of the incident light can define a largest continuous region of incident angle and wavelength that lies within a range of incident angles extending to no more than 80, 75, or 70 degrees and within a predetermined wavelength range extending from about 400 nm to about 2000, 1500, 1000 nm, or 700 nm where the optical transmittance is less than a same first transmittance. The largest continuous region defined under any of these incident angle or wavelength limitations can be larger for the optical film than for the optical stack by any amount described above (e.g., by at least about 10, 20, 30, 50, 70, or 90%), for example.

In some embodiments, as described further elsewhere herein, for a same first wavelength range that is at least about 10 nm wide (or in a range described elsewhere herein) and lies within the predetermined wavelength range, the optical film and stack have respective average optical transmittances S1 and S2 (see, e.g., FIG. 11) in the first wavelength range for a same incident angle of less than about 10 degrees, where S1 and S2 are within about 20% of each other (or in a range described elsewhere herein).

In some embodiments, optical transmittances of the optical stack for a same incident angle and a same wavelength in the predetermined wavelength range are different by at least about 10, 20, 30, 40, or 50% for different first and second azimuthal angles. The first and second azimuthal angles can differ by at least about 10, 20, 30, 40, 50, 60, 70, 80, or 90 degrees, for example. For example, optical transmittances of the optical stack can be significantly different for a first incident plane orthogonal to the y-direction (e.g., when the microstructures extend along the y-direction) than for a second incent plane parallel to, or making an oblique angle with, the y-direction. In some embodiments, a magnitude of a difference between the first and second azimuthal angles is about 180 degrees. For example, optical transmittances of the optical stack can be significantly different for azimuthal angles of φ and φs for a same incident angle and a same incident plane 103 (see, e.g., FIG. 1). When the optical transmittances are significantly different for azimuthal angles of φ and φs for a same incident angle, the optical transmittances is typically also different for the same incident angle and for azimuthal angles of φ and φ+10 or more degrees, for example.

In some embodiments, an optical stack 200, 200′, 300, 400, 500, 600, 700 includes a plurality of microstructures 210, 310, 410, 510, 610, 710 arranged on and across an optical film 220, such that for a substantially collimated incident light 201, for a same first polarization state 104 or 105, for a first incident angle greater than about 10 degrees, for first and second azimuthal angles differing by at least about 10 degrees, and for different first and second wavelengths in a predetermined wavelength range extending from about 400 nm to about 2000 nm: for the first wavelength, optical transmittances of the optical stack for the incident light incident at the first incident angle and the first azimuthal angle and for the incident light incident at the first incident angle and the second azimuthal angle are within about 15 percent of each other; and for the second wavelength, optical transmittances of the optical stack for the incident light incident at the first incident angle and the first azimuthal angle and the incident light incident at the first incident angle and at the second azimuthal angle differ from each other by greater than about 20 percent. In some embodiments, for the first wavelength, optical transmittances of the optical stack for the incident light incident at the first incident angle and the first azimuthal angle and for the incident light incident at the first incident angle and the second azimuthal angle are within about 14, 12, 10, 8, 6, or 4 percent of each other. In some embodiments, for the second wavelength, optical transmittances of the optical stack for the incident light incident at the first incident angle and the first azimuthal angle and the incident light incident at the first incident angle and at the second azimuthal angle differ from each other by greater than about 25, 30, 35, 40, 45, or 50 percent. In some embodiments, a magnitude of a difference between the first and second azimuthal angles is about 180 degrees. In some embodiments, for the first wavelength, the optical transmittance of the optical stack for the first incident angle and for each of the first and second azimuthal angles is greater than about 0.6, 0.65, 0.7, 0.75, 0.8, 0.85, or 0.9. In some embodiments, for the second wavelength, the optical transmittance of the optical stack for the first incident angle and for one, but not the other, of the first and second azimuthal angles is less than about 0.5, 0.45, 0.4, 0.35, 0.3, 0.25, or 0.2. A magnitude of a difference between the first and second wavelengths can be at least about 10, 20, 30, 40, or 50 nm, for example. The magnitude of the difference between the first and second wavelengths can be up to about 1600, 1200, 800, 400, or 300 nm, for example.

For example, referring to FIG. 18, the first wavelength can be about 450 nm and the optical transmittances of the optical stack can be about 0.94 for the incident light incident at the first incident angle (e.g., 50 degrees) and the first azimuthal angle (e.g., 0 degrees) and can be about 0.92 for the incident light incident at the first incident angle and the second azimuthal angle (180 degrees); and the second wavelength can be about 635 nm and optical transmittances of the optical stack can be about 0.72 for the incident light incident at the first incident angle (e.g., 50 degrees) and the first azimuthal angle (e.g., 0 degrees) and can be about 0.15 for the incident light incident at the first incident angle and the second azimuthal angle (e.g., 180 degrees).

In some embodiments, the plurality of microstructures has an optical transmittance having a global minimum at a first wavelength (see, e.g., FIGS. 27-29) for each of a first incident angle less than about 10 degrees and a second incident angle greater than the first incident angle and less than about 60 degrees. In some embodiments, the optical film has an optical transmittance having a first band edge (e.g., along which optical transmittance decreases from greater than about 70% to less than about 30% with increasing wavelength) having a first band edge wavelength where the optical transmittance of the optical film along the band edge is about 50%. The first wavelength of the plurality of microstructures may shift differently than the band edge wavelength with increasing incident angle. In some embodiments, for the first incident angle, the first wavelength is less than the first band edge wavelength; and for the second incident angle, the first wavelength is greater than the first band edge wavelength. In some embodiments, the first band edge wavelength for the first incident angle is greater than the first band edge wavelength for the second incident angle; and the first wavelength for the second incident angle is greater than the first wavelength for the first incident angle.

The dimensions of the microstructures, the number of layers of the optical film and the thicknesses of the layers, and the refractive indices of the microstructures and of the layers of the optical film, for example, that were utilized in the optical modeling of FIGS. 10A-29 are for illustrative purposes. It will be understood that other dimensions, layer number and thickness, and/or other refractive indices, for example, can be used depending on wavelength ranges, for example, where reflectance or transmittance is desired. For example, the optical film 220 can be configured (by suitable selection of total layer number, layer thickness, and refractive indices of the layers) to reflect at least one polarization state over a predetermined wavelength range that may include visible and/or near infrared wavelengths. The predetermined wavelength may extend from a shorter first wavelength to a longer second wavelength and the dimensions (e.g., width, gap, height) of the microstructures may be selected to affect incident light primarily for wavelengths near one of the first and second wavelengths.

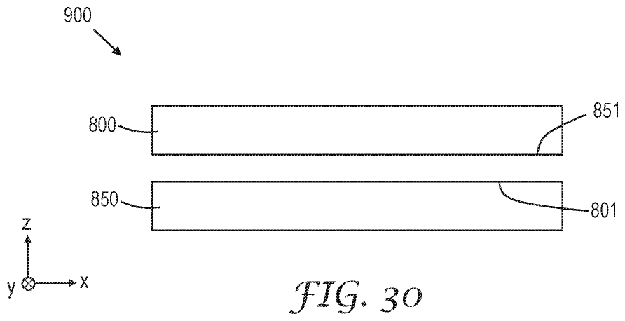

The optical stack stacks of the present description may be utilized, for example, in a wide variety of optical systems where a predetermined wavelength and/or incident angle dependence of transmittance and/or reflectance of the optical stack is desired. FIG. 30 is a schematic cross-sectional view of an optical system 900 including an optical stack 800 and an optical element 850, according to some embodiments. The optical stack 800 can correspond to any of the optical stacks of the present description. The optical element 850 can be any suitable optical element. The optical element 850 may be an optical substrate (e.g., a glass substrate, a polymeric substrate, or an optically active substrate such as a display panel), for example. In some embodiments, the optical element 850 is a display, a sensor (imaging or non-imaging), a window, a light guide, an optical lens, or a light source, for example. In some embodiments, an optical system 900 includes an optical element 850 and an optical stack 800 disposed in optical communication with the optical element 850. The term “optical communication” as applied to two objects means that light can be transmitted from one to the other either directly or indirectly using optical methods (e.g., reflection, diffraction, refraction). In some embodiments, an optical system 900 includes an optical stack 800 disposed (directly or indirectly) on an optical element 850. For example, an optical system 900 can include an optical stack disposed on an optical substrate. The optical stack 800 may be disposed on the optical element 850 with the microstructures of the optical stack 800 facing, or facing away from, the optical element 850 (e.g., so that light from a light source of the optical system, which may the same or different from the optical element 850, is incident on the microstructures before being incident on the optical film of the optical stack 800). The optical stack 800 may be disposed on, and substantially coextensive with, a major surface 851 of the optical element 850. For example, at least about 60, 70, 80, or 90 percent by area of each of a major surface 801 of the optical stack 800 and the major surface 851 can be coextensive with at least about 60, 70, 80, or 90 percent by area of each other of the major surface 801 and the major surface 851. The major surface 851 of the optical element 850 can comprise a light output surface of a display or a light guide or can comprise a light input surface of a sensor, for example.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optical stack comprising a plurality of microstructures arranged on and across an optical film, the plurality of microstructures defining a metasurface or a metagrating, such that for a substantially collimated incident light, a same first polarization state, a same first optical property, and a same first wavelength range that is at least about 10 nm wide and lies within a predetermined wavelength range extending from about 400 nm to about 2000 nm:
the first optical property of the optical film and stack have respective average magnitudes S1 and S2 in the first wavelength range for a same incident angle of less than about 10 degrees, S1 and S2 within about 20% of each other; and
for a first incident angle and a second incident angle that is greater than the first incident angle by at least about 10 degrees, the first optical property of each of the optical film and stack remains within about 20% of a same P1, P1≥0.3 S1, as incident angle and wavelength of the incident light change from the first incident angle at a first wavelength to the second incident angle at a second wavelength, wherein a magnitude of a difference between the first and second wavelengths is greater for the optical film than for the optical stack by at least about 10%.

2. The optical stack of claim 1, wherein the magnitude of the difference between the first and second wavelengths for the optical film is greater than about 20 nm and the magnitude of the difference between the first and second wavelengths for the optical stack is less than about 10 nm.

3. The optical stack of claim 1, wherein the magnitude of the difference between the first and second wavelengths is greater for the optical film than for the optical stack by at least a factor of about 2.

4. The optical stack of claim 1, wherein 0.7≥P1≥0.3.

5. The optical stack of claim 1, wherein the first optical property is optical transmittance or optical reflectance.

6. The optical stack of claim 1, wherein the first incident angle is greater than about 10 degrees.

7. The optical stack of claim 1, wherein the optical film comprises a plurality of alternating first and second layers numbering at least 5 in total, each of the first and second layers having an average thickness of less than about 500 nm.

8. An optical stack comprising a plurality of microstructures arranged on and across an optical film, the plurality of microstructures defining a metasurface or a metagrating, such that for a substantially collimated incident light, a same first polarization state, a same first optical property, and a same first wavelength range that is at least about 10 nm wide and lies within a predetermined wavelength range extending from about 400 nm to about 2000 nm:
the first optical property of the optical film and stack have respective average magnitudes S1 and S2 in the first wavelength range for a same incident angle of less than about 10 degrees, S1 and S2 within about 20% of each other; and
for a first incident angle and a second incident angle that is greater than the first incident angle by at least about 10 degrees, the first optical property of each of the optical film and stack is within about 20% of a same P1, P1≥0.3 S1, as incident angle and wavelength of the incident light changes from the first incident angle at a first wavelength to the second incident angle at a second wavelength, wherein differences between the first and second wavelengths for the optical film and stack have opposite signs.

9. The optical stack of claim 8, wherein:
for the optical film, the first wavelength is greater than the second wavelength by at least about 5 nm; and
for the optical stack, the second wavelength is greater than the first wavelength by at least about 1 nm.

10. The optical stack of claim 8, wherein P1 is about 0.5 and the first optical property is optical transmittance or optical reflectance.

11. The optical stack of claim 8, wherein the optical film comprises a plurality of alternating first and second layers numbering at least 5 in total, each of the first and second layers having an average thickness of less than about 500 nm.

12. An optical stack comprising a plurality of microstructures arranged on and across an optical film, the plurality of microstructures defining a metasurface or a metagrating, such that for a substantially collimated incident light, for a same first polarization state, for a predetermined wavelength range extending from about 400 nm to about 2000 nm, and for a first incident angle less than about 10 degrees and a second incident angle greater than the first incident angle by at least about 30 degrees:
optical transmittance of each of the optical stack and film defines a largest continuous range of wavelength that lies within the predetermined wavelength range where the optical transmittance is no greater than about 25%, the largest continuous range of wavelength extending from a shorter first wavelength to a longer second wavelength,
wherein for at least a same one of the first and second wavelengths, a magnitude of a difference between the wavelength at the first incident angle and the wavelength at the second incident angle is greater for the optical film than for the optical stack by at least about 10%, and
wherein for the optical film and for at least one of the first and second incident angles, a difference between the second and first wavelengths is at least about 1% of an average of the first and second wavelengths.

13. The optical stack of claim 12, wherein for the optical film, the first wavelength at the first incident angle is greater than the first wavelength at the second incident angle by at least about 10 nm.

14. The optical stack of claim 12, wherein the optical film comprises a plurality of alternating first and second layers numbering at least 5 in total, each of the first and second layers having an average thickness of less than about 500 nm.

15. An optical system comprising an optical element and the optical stack of claim 1 disposed in optical communication with the optical element.

16. An optical system comprising an optical element and the optical stack of claim 8 disposed in optical communication with the optical element.

17. An optical system comprising an optical element and the optical stack of claim 12 disposed in optical communication with the optical element.
